(19) United States
(12) Patent Application Publication
(10) Pub. No.: US 2026/0172213 A1
(43) Pub. Date: Jun. 18, 2026

(54) BANDWIDTH PART (BWP) SWITCHING WITH CARRIER AGGREGATION (CA)

(71) Applicant: QUALCOMM Incorporated, San Diego, CA (US)

(72) Inventors: Mostafa KHOSHNEVISAN, San Diego, CA (US); Kianoush HOSSEINI, San Diego, CA (US); Junyi LI, Greentown, PA (US); Jing SUN, San Diego, CA (US)

(21) Appl. No.: 18/986,383

(22) Filed: Dec. 18, 2024

(51) Int. Cl. H04L 5/00; H04L 1/1829; H04W 72/231

(52) U.S. Cl. CPC H04L 5/0098; H04L 1/1854; H04W 72/231

(57) ABSTRACT

Methods, systems, and devices for wireless communications are described. In some systems, a user equipment (UE) may operate according to active bandwidth parts (BWPs) for multiple component carriers (CCs). A network entity may transmit a non-scheduling downlink control information (DCI) message that indicates, to the UE, BWP switches for multiple CCs. The non-scheduling DCI message may repurpose bits from downlink data scheduling fields to indicate the BWP switches. The UE may receive the non-scheduling DCI message and perform the BWP switches for the multiple CCs. If the UE receives multiple DCI messages indicating BWP switches, the UE may perform the BWP switches in accordance with a quantity of CCs for BWP switching and a reference time. The UE may start a BWP switching delay at the reference time, where the reference time is associated with a resource allocated for feedback by at least one of the multiple DCI messages.

### TECHNICAL FIELD

The following relates to wireless communications, including bandwidth part (BWP) switching with carrier aggregation (CA).

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources, such as time, frequency, and power. Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, wireless communication devices may support carrier aggregation (CA). For example, a UE may operate via a set of multiple component carriers (CCs). For each CC, the UE may communicate signaling via an active bandwidth part (BWP), such as an active uplink BWP, an active downlink BWP, or both. A network entity may trigger the UE to switch an active BWP for a CC from a first BWP to a second BWP using a downlink signal, such as a downlink control information (DCI) message. However, transmitting multiple DCI messages to trigger BWP switches for multiple CCs may involve significant signaling overhead and may introduce significant processing latency for the multiple BWP switches.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a user equipment (UE). The UE may include a processing system that includes processor circuitry and memory circuitry that stores code. The processing system may be configured to cause the UE to receive a non-scheduling downlink control information (DCI) signal that indicates a set of multiple active bandwidth part (BWP) switches for a set of multiple respective component carriers (CCs), a first active BWP switch of the set of multiple active BWP switches being associated with an uplink BWP. The processing system may be further configured to cause the UE to communicate in accordance with the set of multiple active BWP switches.

Another innovative aspect of the subject matter described in this disclosure can be implemented in a method for wireless communications. The method may include receiving a non-scheduling DCI signal that indicates a set of multiple active BWP switches for a set of multiple respective CCs, a first active BWP switch of the set of multiple active BWP switches being associated with an uplink BWP. The method may further include communicating in accordance with the set of multiple active BWP switches.

Another innovative aspect of the subject matter described in this disclosure can be implemented in a UE. The UE may include means for receiving a non-scheduling DCI signal that indicates a set of multiple active BWP switches for a set of multiple respective CCs, a first active BWP switch of the set of multiple active BWP switches being associated with an uplink BWP. The UE may further include means for communicating in accordance with the set of multiple active BWP switches.

Another innovative aspect of the subject matter described in this disclosure can be implemented in a non-transitory computer-readable medium storing code for wireless communications. The code may include instructions executable by one or more processors to receive a non-scheduling DCI signal that indicates a set of multiple active BWP switches for a set of multiple respective CCs, a first active BWP switch of the set of multiple active BWP switches being associated with an uplink BWP. The code may further include instructions executable by the one or more processors to communicate in accordance with the set of multiple active BWP switches.

In some examples of the UEs, method, and non-transitory computer-readable medium described herein, the non-scheduling DCI signal further indicates a resource for hybrid automatic repeat request (HARQ) acknowledgment (ACK) feedback. In some such examples, the method, UEs, and non-transitory computer-readable medium may include further operations, features, means, or instructions for transmitting, via the resource for HARQ-ACK feedback, a HARQ-ACK signal that acknowledges reception of the non-scheduling DCI signal.

In some examples of the method, user equipment (UEs), and non-transitory computer-readable medium described herein, one or more fields of the non-scheduling downlink control information signal may be set to one or more reserved values to indicate that the non-scheduling downlink control information signal indicates multi-component carrier bandwidth part switching.

In some examples of the UEs, method, and non-transitory computer-readable medium described herein, a set of bits from one or more fields of the non-scheduling DCI signal indicates one or more identifiers (IDs) of one or more respective target BWPs for one or more respective CCs of the set of multiple respective CCs. In some examples of the UEs, method, and non-transitory computer-readable medium described herein, the non-scheduling DCI signal further indicates a first CC in accordance with one of a carrier indicator field of the non-scheduling DCI signal or the non-scheduling DCI signal being received via the first CC. In some such examples, a BWP indicator field of the non-scheduling DCI signal may indicate an ID of a target BWP for the first CC.

Another innovative aspect of the subject matter described in this disclosure can be implemented in a UE. The UE may include a processing system that includes processor circuitry and memory circuitry that stores code. The processing system may be configured to cause the UE to receive a set of multiple DCI signals that indicate: a set of multiple active BWP switches for a set of multiple respective sets of CCs, and one or more resources for HARQ-ACK feedback. The processing system may be further configured to cause the UE to communicate in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

Another innovative aspect of the subject matter described in this disclosure can be implemented in a method for wireless communications. The method may include receiving a set of multiple DCI signals that indicate: a set of multiple active BWP switches for a set of multiple respective sets of CCs, and one or more resources for HARQ-ACK feedback. The method may further include communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

Another innovative aspect of the subject matter described in this disclosure can be implemented in a UE. The UE may include means for receiving a set of multiple DCI signals that indicate: a set of multiple active BWP switches for a set of multiple respective sets of CCs, and one or more resources for HARQ-ACK feedback. The UE may further include means for communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

Another innovative aspect of the subject matter described in this disclosure can be implemented in a non-transitory computer-readable medium storing code for wireless communications. The code may include instructions executable by one or more processors to receive a set of multiple DCI signals that indicate: a set of multiple active BWP switches for a set of multiple respective sets of CCs, and one or more resources for HARQ-ACK feedback. The code may further include instructions executable by the one or more processors to communicate in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

Some examples of the UEs, method, and non-transitory computer-readable medium described herein may further include operations, features, means, or instructions for starting the BWP switching delay at the reference time. The communicating may occur after a duration of the BWP switching delay.

A method for wireless communications by a network entity is described. The method may include transmitting a non-scheduling downlink control information signal that indicates a set of multiple active bandwidth part switches for a set of multiple respective component carriers, a first active bandwidth part switch of the set of multiple active bandwidth part switches being associated with an uplink bandwidth part and communicating in accordance with the set of multiple active bandwidth part switches.

Another innovative aspect of the subject matter described in this disclosure can be implemented in a network entity. The network entity may include a processing system that includes processor circuitry and memory circuitry that stores code. The processing system may be configured to cause the network entity to transmit a non-scheduling DCI signal that indicates a set of multiple active BWP switches for a set of multiple respective CCs, a first active BWP switch of the set of multiple active BWP switches being associated with an uplink BWP. The processing system may be further configured to cause the network entity to communicate in accordance with the set of multiple active BWP switches.

Another innovative aspect of the subject matter described in this disclosure can be implemented in a method for wireless communications. The method may include transmitting a non-scheduling DCI signal that indicates a set of multiple active BWP switches for a set of multiple respective CCs, a first active BWP switch of the set of multiple active BWP switches being associated with an uplink BWP. The method may further include communicating in accordance with the set of multiple active BWP switches.

Another innovative aspect of the subject matter described in this disclosure can be implemented in a network entity. The network entity may include means for transmitting a non-scheduling DCI signal that indicates a set of multiple active BWP switches for a set of multiple respective CCs, a first active BWP switch of the set of multiple active BWP switches being associated with an uplink BWP. The network entity may further include means for communicating in accordance with the set of multiple active BWP switches.

Another innovative aspect of the subject matter described in this disclosure can be implemented in a non-transitory computer-readable medium storing code for wireless communications. The code may include instructions executable by one or more processors to transmit a non-scheduling DCI signal that indicates a set of multiple active BWP switches for a set of multiple respective CCs, a first active BWP switch of the set of multiple active BWP switches being associated with an uplink BWP. The code may further include instructions executable by the one or more processors to communicate in accordance with the set of multiple active BWP switches.

In some examples of the network entities, method, and non-transitory computer-readable medium described herein, the non-scheduling DCI signal further indicates a resource for HARQ-ACK feedback. In some such examples, the network entities, method, and non-transitory computer-readable medium may include further operations, features, means, or instructions for receiving, via the resource for HARQ-ACK feedback, a HARQ-ACK signal that acknowledges reception of the non-scheduling DCI signal at a UE.

Another innovative aspect of the subject matter described in this disclosure can be implemented in a network entity. The network entity may include a processing system that includes processor circuitry and memory circuitry that stores code. The processing system may be configured to cause the network entity to transmit a set of multiple DCI signals that indicate: a set of multiple active BWP switches for a set of multiple respective sets of CCs, and one or more resources for HARQ-ACK feedback. The processing system may be further configured to cause the network entity to communicate in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

Another innovative aspect of the subject matter described in this disclosure can be implemented in a method for wireless communications. The method may include transmitting a set of multiple DCI signals that indicate: a set of multiple active BWP switches for a set of multiple respective sets of CCs, and one or more resources for HARQ-ACK feedback. The method may further include communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

Another innovative aspect of the subject matter described in this disclosure can be implemented in a network entity. The network entity may include means for transmitting a set of multiple DCI signals that indicate: a set of multiple active BWP switches for a set of multiple respective sets of CCs, and one or more resources for HARQ-ACK feedback. The network entity may further include means for communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

Another innovative aspect of the subject matter described in this disclosure can be implemented in a non-transitory computer-readable medium storing code for wireless communications. The code may include instructions executable by one or more processors to transmit a set of multiple DCI signals that indicate: a set of multiple active BWP switches for a set of multiple respective sets of CCs, and one or more resources for HARQ-ACK feedback. The code may further include instructions executable by the one or more processors to communicate in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

Some examples of the network entities, method, and non-transitory computer-readable medium described herein may further include operations, features, means, or instructions for starting the BWP switching delay at the reference time. The communicating may occur after a duration of the BWP switching delay.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support bandwidth part (BWP) switching with carrier aggregation (CA) in accordance with one or more aspects of the present disclosure.

FIGS. 3A and 3B show example time-frequency resources that support BWP switching with CA in accordance with one or more aspects of the present disclosure.

FIG. 4 shows an example of a downlink control information (DCI) message that supports BWP switching with CA in accordance with one or more aspects of the present disclosure.

FIGS. 5 and 6 show examples of process flows that support BWP switching with CA in accordance with one or more aspects of the present disclosure.

FIGS. 7 and 8 show block diagrams of devices that support BWP switching with CA in accordance with one or more aspects of the present disclosure.

FIG. 9 shows a block diagram of a communications manager that supports BWP switching with CA in accordance with one or more aspects of the present disclosure.

FIG. 10 shows a diagram of a system including a device that supports BWP switching with CA in accordance with one or more aspects of the present disclosure.

FIGS. 11 and 12 show block diagrams of devices that support BWP switching with CA in accordance with one or more aspects of the present disclosure.

FIG. 13 shows a block diagram of a communications manager that supports BWP switching with CA in accordance with one or more aspects of the present disclosure.

FIG. 14 shows a diagram of a system including a device that supports BWP switching with CA in accordance with one or more aspects of the present disclosure.

FIGS. 15-18 show flowcharts illustrating methods that support BWP switching with CA in accordance with one or more aspects of the present disclosure.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing third generation (3G), fourth generation (4G), fifth generation (5G), or sixth generation (6G), or further implementations thereof, technology.

In some wireless communications systems, wireless communication devices may support carrier aggregation (CA). For example, a user equipment (UE) may operate via a set of multiple component carriers (CCs) in accordance with a CA configuration. For a respective CC of the set of multiple CCs, the UE may communicate signaling via an active bandwidth part (BWP), such as an active uplink BWP, an active downlink BWP, or both. In some examples, a network entity may trigger the UE to switch an active BWP for a CC from a first BWP to a second BWP using a downlink signal, such as a downlink control information (DCI) message. However, transmitting multiple DCI messages to trigger BWP switches for multiple CCs of the CA configuration may increase a channel overhead and processing latency associated with BWP switching.

Various aspects relate generally to BWP switching for multiple CCs. Some aspects more specifically relate to triggering BWP switches for multiple CCs using a single non-scheduling downlink DCI message. For example, a network entity may transmit, and a UE may receive, a non-scheduling downlink DCI message that indicates BWP switches for multiple CCs. In some implementations, to support indicating multiple BWP switches, the network entity may repurpose one or more bits of the DCI message that, for a scheduling downlink DCI message, are associated with PDSCH scheduling fields. The repurposed bits, for the non-scheduling downlink DCI message, may instead indicate BWP switching information, such as respective BWP identifiers (IDs) corresponding to target BWPs for BWP switching. In some examples, the network entity may use radio resource control (RRC) signaling to configure BWP ID options for the multiple CCs. The non-scheduling downlink DCI message may enable downlink BWP switching, uplink BWP switching, or a combination thereof for one or more CCs. The UE may perform the indicated BWP switches in accordance with the non-scheduling DCI message, and the UE and network entity may communicate via the target BWPs upon completion of the BWP switches. Additionally, or alternatively, the UE may determine a BWP switching delay for performing the multiple BWP switches. In some examples, the UE may determine the BWP switching delay in accordance with a quantity of CCs for BWP switching and a reference time. The reference time may depend on at least one resource configured for hybrid automatic repeat request (HARQ) acknowledgment (ACK) feedback. For example, if the network entity transmits multiple DCI messages indicating one or more BWP switches, the UE may determine the reference time in accordance with a HARQ-ACK resource configured by at least one of the multiple DCI messages. In some examples, if the multiple DCI messages indicate HARQ-ACK feedback resources that are aligned in time, the reference time may correspond to the aligned HARQ-ACK feedback timing. In some other examples, if the multiple DCI messages indicate HARQ-ACK feedback resources with different timings, the reference time may correspond to an earliest or latest HARQ-ACK feedback timing. The UE and network entity may start the BWP switching delay for performing the multiple BWP switches at the reference time and may communicate via the updated BWPs after the BWP switching delay.

Particular aspects of the subject matter described in this disclosure can be implemented to realize one or more of the following potential advantages. In some examples, by indicating BWP switches for multiple CCs using a single non-scheduling DCI message (for example, rather than using multiple separate DCI messages), the network entity and the UE may reduce a signaling overhead, processing overhead, and processing latency associated with triggering multiple BWP switches. Additionally, or alternatively, the non-scheduling DCI message may improve BWP switching flexibility by supporting both uplink and downlink BWP switching indications in a single message. In some examples, by repurposing bits of the DCI message to indicate the BWP IDs, the network entity may maintain a DCI message size, improving signaling reliability and coordination between the UE and network entity. Furthermore, by using non-scheduling DCI, the UE and the network entity may better align on whether the UE successfully received the DCI message triggering the BWP switches. For example, a negative acknowledgment (NACK) transmitted in response to a scheduling DCI message may fail to indicate whether the scheduling DCI is not decoded by the UE or the data transmission scheduled by the DCI is not decoded by the UE. In contrast, a NACK transmitted in response to a non-scheduling DCI message may accurately indicate that the non-scheduling DCI message is not decoded by the UE, supporting improved coordination between the UE and the network entity regarding whether the BWP switching indication is successfully received. Additionally, or alternatively, if the UE receives multiple DCI messages indicating BWP switches, the UE may improve communication reliability by using the reference time associated with at least one resource configured for HARQ-ACK feedback. For example, the UE and network entity may both determine the same reference time, improving coordination between the UE and network entity. By starting the BWP switching delay at the reference time, the UE and network entity may ensure that the UE is scheduled for communications after (and not during) the BWP switching delay. For example, if the reference time corresponds to the latest HARQ-ACK feedback timing, the BWP switching delay may grant the UE enough time to complete the BWP switching for multiple CCs, such that completion of the BWP switching occurs at the same time for the multiple CCs.

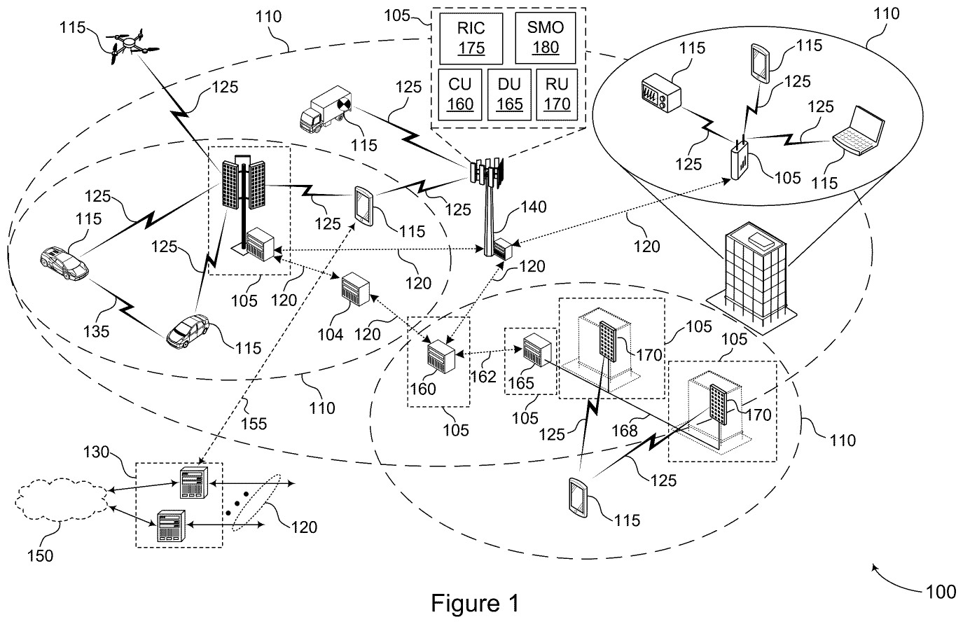

FIG. 1 shows an example of a wireless communications system 100 that supports BWP switching with CA in accordance with one or more aspects of the present disclosure. The wireless communications system 100 may include one or more devices, such as one or more network devices (for example, network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (for example, a radio frequency (RF) access link). For example, a network entity 105 may support a coverage area 110 (for example, a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (for example, other wireless communication devices, including UEs 115 or network entities 105), as shown in FIG. 1.

A node of the wireless communications system 100, which may be referred to as a network node, or a wireless node, may be a network entity 105 (for example, any network entity described herein), a UE 115 (for example, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system, among other examples may include disclosure of the UE 115, network entity 105, apparatus, device, or computing system, among other examples being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (for example, in accordance with an S1, N2, N3, or other interface protocol). In some examples, network entities 105 may communicate with one another via backhaul communication link(s) 120 (for example, in accordance with an X2, Xn, or other interface protocol) either directly (for example, directly between network entities 105) or indirectly (for example, via the core network 130). In some examples, network entities 105 may communicate with one another via a midhaul communication link 162 (for example, in accordance with a midhaul interface protocol) or a fronthaul communication link 168 (for example, in accordance with a fronthaul interface protocol), or any combination thereof. The backhaul communication link(s) 120, midhaul communication links 162, or fronthaul communication links 168 may be or include one or more wired links (for example, an electrical link, an optical fiber link) or one or more wireless links (for example, a radio link, a wireless optical link), among other examples or various combinations thereof. A UE 115 may communicate with the core network 130 via a communication link 155.

One or more of the network entities 105 or network equipment described herein may include or may be referred to as a base station 140 (for example, a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (for example, a base station 140) may be implemented in an aggregated (for example, monolithic, standalone) base station architecture, which may be configured to utilize a protocol stack that is physically or logically integrated within one network entity (for example, a network entity 105 or a single RAN node, such as a base station 140).

In some examples, a network entity 105 may be implemented in a disaggregated architecture (for example, a disaggregated base station architecture, a disaggregated RAN architecture), which may be configured to utilize a protocol stack that is physically or logically distributed among multiple network entities (for example, network entities 105), such as an integrated access and backhaul (IAB) network, an open RAN (O-RAN) (for example, a network configuration sponsored by the O-RAN Alliance), or a virtualized RAN (vRAN) (for example, a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (for example, a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (for example, separate physical locations). In some examples, one or more of the network entities 105 of a disaggregated RAN architecture may be implemented as virtual units (for example, a virtual CU (VCU), a virtual DU (VDU), a virtual RU (VRU)).

The split of functionality between a CU 160, a DU 165, and an RU 170 is flexible and may support different functionalities depending on which functions (for example, network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (for example, layer 3 (L3), layer 2 (L2)) functionality and signaling (for example, RRC, service data adaptation protocol (SDAP), Packet Data Convergence Protocol (PDCP)). The CU 160 (for example, one or more CUs) may be connected to a DU 165 (for example, one or more DUs) or an RU 170 (for example, one or more RUs), or some combination thereof, and the DUs 165, RUs 170, or both may host lower protocol layers, such as layer 1 (L1) (for example, physical (PHY) layer) or L2 (for example, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (for example, via one or multiple different RUs, such as an RU 170). In some examples, a functional split between a CU 160 and a DU 165 or between a DU 165 and an RU 170 may be within a protocol layer (for example, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (for example, F1, F1-c, F1-u), and a DU 165 may be connected to an RU 170 via a fronthaul communication link 168 (for example, open fronthaul (FH) interface). In some examples, a midhaul communication link 162 or a fronthaul communication link 168 may be implemented in accordance with an interface (for example, a channel) between layers of a protocol stack supported by respective network entities (for example, one or more of the network entities 105) that are in communication via such communication links.

In some wireless communications systems (for example, the wireless communications system 100), infrastructure and spectral resources for radio access may support wireless backhaul link capabilities to supplement wired backhaul connections, providing an IAB network architecture (for example, to a core network 130). In some examples, in an IAB network, one or more of the network entities 105 (for example, network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (for example, IAB donors) may be in communication with one or more additional devices (for example, IAB node(s) 104) via supported access and backhaul links (for example, backhaul communication link(s) 120). IAB node(s) 104 may include an IAB mobile termination (IAB-MT) controlled (for example, scheduled) by one or more DUs (for example, DUs 165) of a coupled IAB donor. An IAB-MT may be equipped with an independent set of antennas for relay of communications with UEs 115 or may share the same antennas (for example, of an RU 170) of IAB node(s) 104 used for access via the DU 165 of the IAB node(s) 104 (for example, referred to as virtual IAB-MT (vIAB-MT)). In some examples, the IAB node(s) 104 may include one or more DUs (for example, DUs 165) that support communication links with additional entities (for example, IAB node(s) 104, UEs 115) within the relay chain or configuration of the access network (for example, downstream). In such examples, one or more components of the disaggregated RAN architecture (for example, the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support BWP switching with CA. For example, some operations described as being performed by a UE 115 or a network entity 105 (for example, a base station 140) may additionally, or alternatively, be performed by one or more components of the disaggregated RAN architecture (for example, components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology. The “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (for example, one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (for example, a BWP) that is operated according to one or more PHY layer channels for a given RAT (for example, LTE, LTE-A, LTE-A Pro, NR). Each PHY layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a CA configuration. CA may be used with both frequency-division duplexing (FDD) and time-division duplexing (TDD) CCs. Communication between a network entity 105 and other devices may refer to communication between the devices and any portion (for example, entity, sub-entity) of a network entity 105. For example, the terms “transmitting,” “receiving,” or “communicating,” when referring to a network entity 105, may refer to any portion of a network entity 105 (for example, a base station 140, a CU 160, a DU 165, a RU 170) of a RAN communicating with another device (for example, directly or via one or more other network entities, such as one or more of the network entities 105).

In some examples, such as in a CA configuration, a carrier may have acquisition signaling or control signaling that coordinates operations for other carriers. A carrier may be associated with a frequency channel (for example, an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (for example, of the same or a different RAT).

The communication link(s) 125 of the wireless communications system 100 may include downlink transmissions (for example, forward link transmissions) from a network entity 105 to a UE 115, uplink transmissions (for example, return link transmissions) from a UE 115 to a network entity 105, or both, among other configurations of transmissions. Carriers may carry downlink or uplink communications (for example, in an FDD mode) or may be configured to carry downlink and uplink communications (for example, in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (for example, 1.4, 3, 5, 10, 15, 20, 40, or 80 megahertz (MHz)). Devices of the wireless communications system 100 (for example, the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (for example, a sub-band, a BWP) or all of a carrier bandwidth.

Signal waveforms transmitted via a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (for example, a duration of one modulation symbol) and one subcarrier, in which case the symbol period and subcarrier spacing may be inversely related. The quantity of bits carried by each resource element may depend on the modulation scheme (for example, the order of the modulation scheme, the coding rate of the modulation scheme, or both), such that a relatively higher quantity of resource elements (for example, in a transmission duration) and a relatively higher order of a modulation scheme may correspond to a relatively higher rate of communication. A wireless communications resource may refer to a combination of an RF spectrum resource, a time resource, and a spatial resource (for example, a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively-numbered subframes or slots, and each subframe or slot may have the same duration. In some examples, a frame may be divided (for example, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (for example, depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, a quantity of symbol periods in a TTI) may be variable. Additionally, or alternatively, the smallest scheduling unit of the wireless communications system 100 may be dynamically selected (for example, in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a set of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (for example, control channel elements (CCEs)) associated with encoded information for a control information format having a given payload size. Search space sets may include common search space sets configured for sending control information to UEs 115 (for example, one or more UEs) or may include UE-specific search space sets for sending control information to a UE 115 (for example, a specific UE).

In some examples, a network entity 105 (for example, a base station 140, an RU 170) may be movable and provide communication coverage for a moving coverage area, such as the coverage area 110. In some examples, coverage areas 110 (for example, different coverage areas) associated with different technologies may overlap, but the coverage areas 110 (for example, different coverage areas) may be supported by the same network entity (for example, a network entity 105). In some other examples, overlapping coverage areas, such as a coverage area 110, associated with different technologies may be supported by different network entities (for example, the network entities 105). The wireless communications system 100 may include, for example, a heterogeneous network in which different types of the network entities 105 support communications for coverage areas 110 (for example, different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (for example, one or more of the UEs 115) via a device-to-device (D2D) communication link, such as a D2D communication link 135 (for example, in accordance with a peer-to-peer (P2P), D2D, or sidelink protocol). In some examples, one or more UEs 115 of a group that are performing D2D communications may be within the coverage area 110 of a network entity 105 (for example, a base station 140, an RU 170), which may support aspects of such D2D communications being configured by (for example, scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (for example, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (for example, less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (for example, LAA). Operations using unlicensed spectrum may include downlink transmissions, uplink transmissions, P2P transmissions, or D2D transmissions, among other examples.

A network entity 105 (for example, a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (for example, a network entity 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority management and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (for example, the communication link(s) 125, a D2D communication link 135). HARQ may include a combination of error detection (for example, using a cyclic redundancy check (CRC)), forward error correction (FEC), and retransmission (for example, automatic repeat request (ARQ)). HARQ may improve throughput at the MAC layer in relatively poor radio conditions (for example, low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support BWP switching for one or more CCs in a CA configuration. For example, a UE 115 may support multiple CCs. For a respective CC, the UE 115 may operate according to an active BWP (for example, a first BWP) within a carrier bandwidth for uplink communications, downlink communications, or both. To perform a BWP switch, the UE 115 may deactivate the first BWP and activate a second, different BWP within the carrier bandwidth of the respective CC. This second BWP may be referred to as a “target,” “updated,” or “new” BWP for the CC. The BWP switch may involve the UE 115 changing a set of parameters for communication and tuning its radio (for example, a receiver, transmitter, transceiver, or some combination thereof) from the first BWP to the second BWP. Performing the BWP switch may involve a processing overhead and latency at the UE 115 to reconfigure the communication parameters and radio for communications via the second BWP.

The wireless communications system 100 may support multiple mechanisms for triggering a BWP switch. In some examples, a network entity 105 may trigger a BWP switch using a DCI message. Multiple DCI formats may support indicating a BWP switch. For example, DCI scheduling a PDSCH transmission (such as a downlink DCI with DCI format 1_1 or 1_2) or DCI scheduling a PUSCH transmission (such as an uplink DCI with DCI format 0_1 or 0_2) may trigger a BWP switch via L1 signaling. The network entity 105 may transmit the DCI message to a UE 115 to trigger the UE 115 to perform the BWP switch. In some other examples, the network entity 105 may trigger a BWP switch using an RRC message. In yet some other examples, the UE 115 may trigger a BWP switch in accordance with a timer. For example, if a BWP inactivity timer expires at the UE 115, the UE 115 may automatically fall back to a default BWP via a BWP switch.

During a BWP switch, the UE 115 may refrain from communicating wireless signaling. For example, the network entity 105 may refrain from scheduling the UE 115 for transmitting or receiving signals during the BWP switch. The UE 115 may perform the BWP switch during a BWP switch delay. A duration of the BWP switch delay may depend on one or more capabilities of the UE 115. For example, the duration of the BWP switch delay may be greater than or equal to a latency associated with the UE 115 reconfiguring communication parameters for wireless communications via the second BWP. The UE 115 may measure the BWP switch delay from the beginning of a slot via which the message triggering the BWP switch is received, from the end of the message (for example, a last symbol of the DCI) triggering the BWP switch, or directly after the BWP inactivity timer expires. In some examples, the UE 115 may use a timer to track the BWP switch delay. The UE 115 may communicate via the second BWP after the BWP switch delay (for example, after the BWP switch delay timer expires). For example, the network entity 105 may schedule the UE 115 for transmitting or receiving signals via the second BWP after the BWP switch delay.

Some systems may support mechanisms for indicating BWP switches for multiple CCs using a single DCI message. In some examples, a DCI message with a secondary cell (SCell) dormancy indication may provide limited BWP switching for multiple CCs. For example, the DCI message (such as a scheduling or non-scheduling DCI message) communicated via a primary cell (PCell) may indicate either a dormant or non-dormant BWP for each CC of a set of multiple CCs. However, such BWP switching may be specific to an SCell, and the DCI signaling is received via the PCell. Additionally, the BWP switching may be limited to switching a CC between dormant and non-dormant BWPs for downlink. The DCI message with the SCell dormancy indication may fail to support uplink BWP switching, as well as fail to support BWP switching from one non-dormant BWP to a different non-dormant BWP. In some other examples, a scheduling DCI message that schedules multiple data transmissions (via multiple CCs) may indicate a BWP ID for the multiple CCs. However, because such a multi-CC scheduling DCI message includes one BWP ID field, the DCI message is limited to indicating the same BWP ID for all of the CCs of the multiple CCs. The multi-CC scheduling DCI message may fail to support BWP switching to different BWP IDs, as well as fail to support both uplink and downlink BWP switching. Such mechanisms may limit BWP switching flexibility for wireless communication devices.

In contrast, the wireless communications system 100 may support triggering BWP switching for multiple CCs using one non-scheduling DCI message. For example, a network entity 105 may transmit, to a UE 115, a DCI message that indicates BWP switches for multiple CCs. The BWP switches may include uplink BWP switching, downlink BWP switching, or a combination thereof. The DCI message may be an example of a DCI signal configured according to a non-scheduling downlink DCI format, such as a DCI format 1_0, 1_1, or 1_2. For example, scheduling downlink DCI formats may include bits that indicate scheduling information for PDSCH transmissions. The network entity 105 may repurpose one or more of these bits in the non-scheduling downlink DCI format to instead indicate BWP switching information, such as target BWP IDs, for one or more CCs. The repurposed bits may indicate different target BWP IDs for different respective CCs, improving the flexibility of indicating multiple BWP switches. Using a single DCI message to indicate BWP switches for multiple CCs may further improve the reliability of BWP switching. Additionally, or alternatively, the wireless communications system 100 may reduce a latency and overhead associated with performing multiple BWP switches by triggering the multiple BWP switches using a single DCI message.

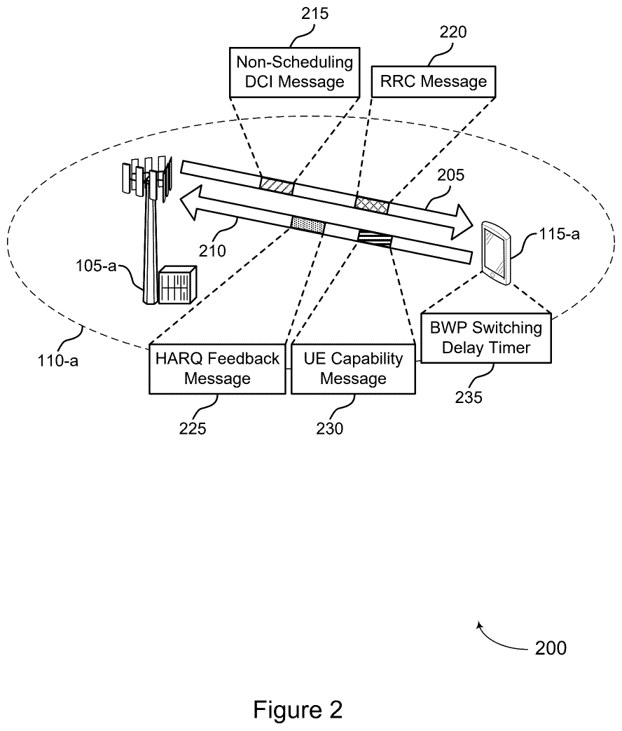

FIG. 2 shows an example of a wireless communications system 200 that supports BWP switching with CA in accordance with one or more aspects of the present disclosure. The wireless communications system 200 may be an example of a wireless communications system 100 as described with reference to FIG. 1. The wireless communications system 200 may include a network entity 105-a and a UE 115-a, which may be respective examples of a network entity 105 and a UE 115 as described with reference to FIG. 1. The network entity 105-a may provide network service for a coverage area 110-a. The network entity 105-a may configure the UE 115-a with a set of CCs for wireless communication. For a CC of the set of CCs, the UE 115-a may operate according to one or more active BWPs (for example, an active downlink BWP for a downlink channel 205 and an active uplink BWP for an uplink channel 210). The UE 115-a may communicate with the network entity 105-a via one or more active BWPs. The wireless communications system 200 may support the network entity 105-a triggering active BWP switches for multiple CCs using a single non-scheduling DCI message 215. Using one DCI message to trigger multi-CC BWP switching, as compared to using multiple DCI messages to trigger BWP switching for respective CCs, may improve a processing overhead and channel overhead associated with BWP switching operations at the UE 115-a, the network entity 105-a, or both.

The network entity 105-a may transmit the non-scheduling DCI message 215 indicating multi-CC BWP switching to the UE 115-a. For example, the non-scheduling DCI message 215 may support indicating one or more downlink BWP switches for one or more CCs, one or more uplink BWP switches for one or more CCs, or a combination of downlink and uplink BWP switches for one or more CCs. Because the non-scheduling DCI message 215 does not schedule a data transmission, such as a PDSCH transmission, bits used for scheduling data transmissions in a scheduling DCI message may be repurposed in the non-scheduling DCI message 215 to instead indicate BWP switching information. Additionally, a new DCI format or DCI size (compared to scheduling DCI) to indicate BWP switching for multiple CCs may be avoided, which may reduce the blind decoding processes and complexity at the UE 115-a. For example, the network entity 105-a generating the non-scheduling DCI message 215 may repurpose M bits from PDSCH scheduling fields to instead indicate one or more target BWPs for BWP switching. In some examples, the non-scheduling DCI message 215 may indicate respective BWP IDs corresponding to target BWPs for multiple CCs.

In some examples, the network entity 105-a may configure the UE 115-a with one or more parameters supporting the multi-CC BWP switching. For example, the network entity 105-a may transmit an RRC message 220 that indicates, to the UE 115-a, respective quantities of bits for indicating BWP IDs for each CC of a set of CCs, respective BWP ID options supported for each CC of the set of CCs, supported combinations of BWP IDs for the set of CCs, or some combination thereof. The M bits of the non-scheduling DCI message 215 may indicate BWP IDs for the set of CCs in accordance with the RRC configuration. In some implementations, the UE 115-a may determine whether or not to perform a BWP switch for a CC according to the indicated BWP IDs. For example, if the UE 115-a communicates via a first BWP associated with a first BWP ID for a first CC, and the non-scheduling DCI message 215 indicates a second BWP ID for the first CC that is different than the first BWP ID, the UE 115-a may perform a BWP switch for the first CC from the first BWP to a second BWP associated with the second BWP ID. Additionally, or alternatively, if the UE 115-a communicates via a third BWP associated with a third BWP ID for a second CC, and the non-scheduling DCI message 215 indicates the third BWP ID for the second CC (that is, the same BWP ID as for the currently active BWP for the second CC), the UE 115-a may maintain the third BWP as the active BWP for the second CC. For example, the UE 115-a may refrain from performing a BWP switch for the second CC in accordance with the BWP ID indication for the second CC in the non-scheduling DCI message 215.

Additionally, or alternatively, the network entity 105-a may configure the UE 115-a with additional parameters regarding uplink and downlink BWP switching indications. For example, the network entity 105-a may transmit an RRC message 220 that indicates a first subset of CCs for which the non-scheduling DCI message 215 indicates a single BWP ID for both uplink and downlink BWPs, a second subset of CCs for which the non-scheduling DCI message 215 indicates separate BWP IDs for uplink or downlink BWPs, or both. In some examples, the first subset and the second subset may depend on duplexing modes for the CCs.

In some examples, the UE 115-a may transmit, to the network entity 105-a, a UE capability message 230 indicating one or more capabilities of the UE 115-a. For example, the UE capability message 230 may indicate that the UE 115-a supports multi-CC BWP switching according to a single non-scheduling DCI message 215. Additionally, or alternatively, the UE capability message 230 may indicate a relaxation of a BWP switching restriction in accordance with one or more capabilities of the UE 115-a. In some examples, the UE capability message 230 may indicate one or more parameters associated with a BWP switching delay for the UE 115-a.

In some implementations, the non-scheduling DCI message 215 may additionally include a resource allocation for HARQ feedback. The UE 115-a may use the allocated HARQ resources for confirming reception of the non-scheduling DCI message 215. For example, the UE 115-a may transmit a HARQ feedback message 225 via the allocated HARQ resources. The HARQ feedback message 225 may confirm successful reception of the non-scheduling DCI message 215 at the UE 115-a.

If the non-scheduling DCI message 215 indicates multi-CC BWP switching, the UE 115-a may determine timing for performing the BWP switches in accordance with a BWP switching delay timer 235. The BWP switching delay timer 235 may define a time duration, TMultipleBWPSwitchDelay, for the UE 115-a to perform the multiple BWP switches. For example, the value of TMultipleBWPSwitchDelay may depend on a capability of the UE 115-a to switch active BWPs. In some examples, switching BWPs for multiple CCs concurrently may involve additional processing time, as compared to switching one BWP for a single CC. In some such examples, the value of TMultipleBWPSwitchDelay may depend on a quantity of CCs for concurrent BWP switching. For example, the time duration for the BWP switching delay timer 235 for multiple CCs may be defined according to Equation 1.

$$TMultipleBWPSwitchDelay = TBWPswitchDelay + D * ( N - 1 ) \qquad ( 1 )$$

In Equation 1, TBWPswitchDelay may be the time duration for performing one BWP switch for a single CC, D may be an additional delay factor, and N may be the quantity of CCs for concurrent BWP switching. In some examples, the additional delay factor D may be specific to the UE 115-a according to one or more UE capabilities.

For DCI-based BWP switching for multiple CCs, after the UE 115-a receives the BWP switching request (for example, via the non-scheduling DCI message 215), the UE 115-a may be able to receive PDSCH (for a downlink active BWP switch) or transmit PUSCH (for an uplink active BWP switch) via the new BWPs on the serving cells for which the BWP switch on the first downlink or uplink slot occurs right after a time duration of TMultipleBWPSwitchDelay. The time duration TMultipleBWPSwitchDelay may start from the beginning of a slot (for example, a downlink slot) n. In some examples, the slot n may be the slot via which the UE 115-a receives an earliest BWP switching request among CCs for which the UE 115-a is performing concurrent (such as simultaneous) DCI-based BWP switching. In some other examples, the slot n may be the slot via which the UE 115-a transmits the HARQ feedback message 225 for the DCI indicating the BWP switching request. That is, in some such other examples, the time for the BWP switch may start after the HARQ-ACK transmission for the non-scheduling DCI message 215 that indicates the BWP switch.

In some examples, the network entity 105-a may transmit multiple DCI messages indicating BWP switches for one or more CCs. Such DCI messages may indicate a BWP switch for a single CC or may indicate BWP switches for multiple CCs (for example, if the DCI message is a non-scheduling DCI message 215). The multiple DCI messages may each indicate HARQ-ACK resources. The UE 115-a may determine the timing for performing the BWP switches (and, correspondingly, the timing for starting the time duration TMultipleBWPSwitchDelay) in accordance with a reference time associated with at least one of the indicated HARQ-ACK resources. In some examples, if the multiple DCI messages indicate HARQ-ACK resources that are aligned in time (or indicate the same HARQ-ACK resource, such as the same PUCCH resource for carrying respective HARQ feedback messages 225), the UE 115-a may transmit multiple HARQ-ACK indications (for example, in one or more HARQ feedback messages 225) for the multiple DCI messages at the same time, such as via the same slot, via the same PUCCH resource, or in the same HARQ-ACK feedback payload. In some such examples, slot n (the slot at with the time duration TMultipleBWPSwitchDelay starts) may be the slot via which the UE 115-a transmits the one or more HARQ feedback messages 225 for the multiple DCI messages. In some other examples, if the multiple DCI messages indicate HARQ-ACK resources with different feedback timings, the UE 115-a may transmit multiple HARQ feedback messages 225 for the multiple DCI messages at the different feedback timings. In some such other examples, slot n (the slot at with the time duration TMultipleBWPSwitchDelay starts) may be the slot via which the UE 115-a transmits one of the multiple HARQ feedback messages 225. For example, slot n may be an earliest slot via which the UE 115-a transmits a HARQ feedback message 225 for DCI including a BWP switching request or a latest slot via which the UE 115-a transmits a HARQ feedback message 225 for DCI including a BWP switching request.

The UE 115-a may perform the BWP switches starting at slot n, such that the UE 115-a completes the BWP switches at or before the expiration of the time duration TMultipleBWPSwitchDelay. The network entity 105-a may similarly perform the BWP switches for the UE 115-a in accordance with slot n and the time duration TMultipleBWPSwitchDelay, such that the UE 115-a and the network entity 105-a are coordinated in time and active BWPs. The UE 115-a and the network entity 105-a may communicate via one or more of the updated active BWPs for the multiple CCs following completion of the BWP switches (for example, after expiration of the time duration TMultipleBWPSwitchDelay).

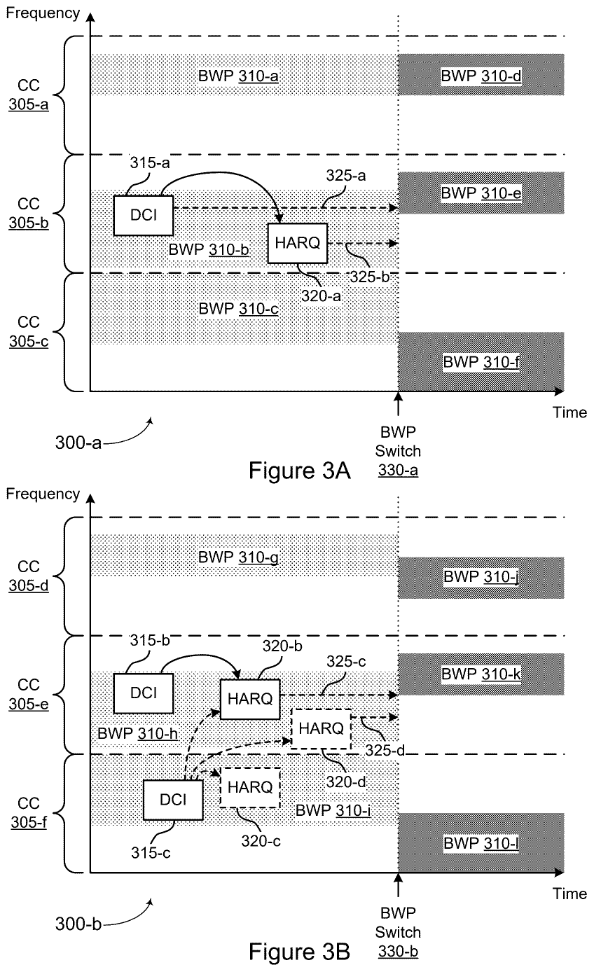

FIGS. 3A and 3B show examples of time-frequency resources that support BWP switching with CA in accordance with one or more aspects of the present disclosure. FIG. 3A shows an example of time-frequency resources 300-a that support multi-CC BWP switching using a single DCI message 315-a. A UE, such as a UE 115 as described with reference to FIGS. 1 and 2, may operate according to multiple CCs, such as a first CC 305-a, a second CC 305-b, and a third CC 305-c. A network entity, such as a network entity 105 as described with reference to FIGS. 1 and 2, may transmit the DCI message 315-a to the UE 115 to indicate BWP switches for multiple CCs.

In some examples, the UE 115 may operate with a first active BWP 310-a for the first CC 305-a, a second active BWP 310-b for the second CC 305-b, and a third active BWP 310-c for the third CC 305-c. The active BWPs may be examples of uplink BWPs, downlink BWPs, or both. The network entity 105 may transmit, and the UE 115 may receive, the DCI message 315-a via any active downlink BWP, such as the second active BWP 310-b for the second CC 305-b.

The DCI message 315-a may be an example of a non-scheduling downlink DCI message, such as a non-scheduling DCI message 215 described with reference to FIG. 2. The DCI message 315-a may indicate multiple BWP IDs for multiple CCs supported by the UE 115. For example, the DCI message 315-a may indicate a first BWP ID for the second CC 305-b and a second BWP ID for the third CC 305-c. The first BWP ID may correspond to a BWP 310-e that is different than the second active BWP 310-b for the CC 305-b. Similarly, the second BWP ID may correspond to a BWP 310-f that is different than the third active BWP 310-c for the CC 305-c. In some examples, the DCI message 315-a may not indicate a BWP ID for the first CC 305-a, such that the UE 115 maintains the first active BWP 310-a for the first CC 305-a through a BWP switch 330-a. In some other examples, the DCI message 315-a may indicate a third BWP ID for the first CC 305-a. The third BWP ID may correspond to a BWP 310-d that is the same as the first active BWP 310-a for the first CC 305-a. The UE 115 may determine not to perform a BWP switch 330-a for the first CC 305-a according to the indicated third BWP ID.

The DCI message 315-a may allocate HARQ-ACK resources for transmission of a HARQ feedback message 320-a by the UE 115. The HARQ feedback message 320-a may confirm successful reception of the DCI message 315-a by the UE 115. In some implementations, the time for performing the BWP switch across the multiple CCs may start after the DCI message 315-a is received. For example, the UE 115 may start a BWP switching delay 325-a after the DCI message 315-a and may perform the BWP switch 330-a during the BWP switching delay 325-a. In some other implementations, the time for performing the BWP switch across the multiple CCs may start after the HARQ feedback message 320-a transmission. For example, the UE 115 may start a BWP switching delay 325-b after the HARQ feedback message 320-a and may perform the BWP switch 330-a during the BWP switching delay 325-b. After the BWP switch 330-a, the UE 115 may operate with the BWP 310-d (for example, the active BWP 310-a) as the active BWP for the first CC 305-a, the BWP 310-e as the new active BWP for the second CC 305-b, and the BWP 310-f as the new active BWP for the third CC 305-c for CA.

FIG. 3B shows an example of time-frequency resources 300-b that support BWP switch timing in accordance with multiple DCI messages indicating BWP switches. A UE, such as a UE 115 as described with reference to FIGS. 1 and 2, may operate according to multiple CCs, such as a first CC 305-d, a second CC 305-e, and a third CC 305-f. A network entity, such as a network entity 105 as described with reference to FIGS. 1 and 2, may transmit multiple DCI messages to the UE 115 to indicate BWP switches for multiple CCs. The UE 115 may determine timing for performing a BWP switch 330-b for the multiple CCs in accordance with one or more of the DCI messages.

In some examples, the UE 115 may operate with a first active BWP 310-g for the first CC 305-d, a second active BWP 310-h for the second CC 305-e, and a third active BWP 310-i for the third CC 305-f. The active BWPs may be examples of uplink BWPs, downlink BWPs, or both. The network entity 105 may transmit, and the UE 115 may receive, multiple DCI messages via any active downlink BWPs. For example, the network entity 105 may transmit a first DCI message 315-b via the second active BWP 310-h for the second CC 305-e and a second DCI message 315-c via the third active BWP 310-i for the third CC 305-f. In some examples, the first DCI message 315-b may indicate a BWP switch from the second active BWP 310-h to a BWP 310-k for the CC 305-e. The second DCI message 315-c may indicate multiple BWP switches for multiple CCs, such as a BWP switch from the first active BWP 310-g to a BWP 310-j for the first CC 305-d and a BWP switch from the third active BWP 310-i to a BWP 310-1 for the third CC 305-f.

The multiple DCI messages may allocate HARQ-ACK resources for transmission of HARQ-ACK feedback. In some implementations, the UE 115 may start a BWP switching delay after transmission of the associated HARQ-ACK feedback. If two or more DCI messages indicate BWP switches for corresponding two or more sets of CCs, the BWP switching delay may be a function of the quantity of CCs in the two or more sets of CCs for BWP switching and a reference time. A “set” of CCs for BWP switching may be a single CC or multiple CCs. For example, the first DCI message 315-b and the second DCI message 315-c may indicate BWP switches for two sets of CCs, the first DCI message 315-b indicating BWP switching for a first set of CCs including just the second CC 305-e and the second DCI message 315-c indicating BWP switching for a second set of CCs including two CCs (the first CC 305-d and the third CC 305-f). The UE 115 may determine the BWP switching delay (for example, TMultipleBWPSwitchDelay) in accordance with a quantity of three CCs and may start the BWP switching delay at the reference time.

The two or more DCI messages may indicate timing for two or more HARQ-ACK feedback indications. In some examples, the timing of the two or more HARQ-ACK feedback indications may be the same. For example, the two or more DCI messages may indicate HARQ-ACK feedback resources that are aligned in time or may indicate for the UE 115 to transmit a single HARQ feedback message 320-b including the two or more HARQ-ACK feedback indications in its payload. For example, the first DCI message 315-b may allocate HARQ-ACK resources for transmission of a HARQ feedback message 320-b by the UE 115, and the second DCI message 315-c may allocate the same HARQ-ACK resources for transmission of the HARQ feedback message 320-b by the UE 115. The UE 115 may transmit one or more HARQ feedback messages via the same HARQ-ACK resource with HARQ-ACK information for both the first DCI message 315-b and the second DCI message 315-c. In another example, the first DCI message 315-b may allocate HARQ-ACK resources for transmission of a HARQ feedback message 320-b by the UE 115, and the second DCI message 315-c may allocate HARQ-ACK resources for transmission of a HARQ feedback message 320-c aligned in time with the HARQ feedback message 320-b transmission. In some such examples, a restriction at the network entity 105, the UE 115, or both may ensure that the HARQ-ACK feedback messages are transmitted via the same slot. The reference time for starting the BWP switching delay 325-c may be the feedback timing for the HARQ-ACK feedback messages. In some implementations, the UE 115 may use the slot (or the end of the PUCCH resource containing HARQ feedback messages) for the aligned HARQ-ACK feedback resources as the start time, rather than determining a reference time. In such implementations, the slot (or the end of the PUCCH resource) for the aligned HARQ-ACK feedback resources may still be referred to as a “reference time.”

In some other examples, the timing of the two or more HARQ-ACK feedback indications may be different. For example, the first DCI message 315-b may indicate a first HARQ-ACK feedback timing for a HARQ feedback message 320-b and the second DCI message 315-c may indicate a second HARQ-ACK feedback timing for a HARQ feedback message 320-d that is different than the first HARQ-ACK feedback timing. The UE 115 may select, or otherwise determine, the reference time from among the different HARQ-ACK feedback timings. In some implementations, the UE 115 may select an earliest HARQ-ACK feedback timing as the reference time, such that the UE 115 starts the BWP switching delay 325-c at a slot via which the HARQ feedback message 320-b is transmitted. In some other implementations, the UE 115 may select a latest HARQ-ACK feedback timing as the reference time, such that the UE 115 starts the BWP switching delay 325-d at a slot via which the HARQ feedback message 320-d is transmitted.

The UE 115 may perform the BWP switch 330-b for the two or more sets of CCs during the BWP switching delay. After the BWP switch 330-b, the UE 115 may operate with the BWP 310-j as the new active BWP for the first CC 305-d, the BWP 310-k as the new active BWP for the second CC 305-e, and the BWP 310-1 as the new active BWP for the third CC 305-f for CA.

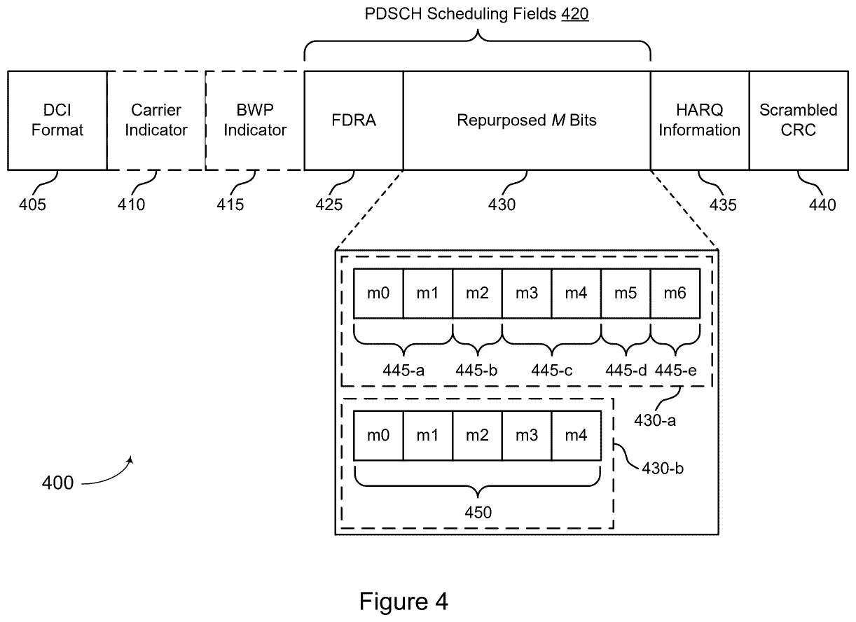

FIG. 4 shows an example of a DCI message 400 that supports BWP switching with CA in accordance with one or more aspects of the present disclosure. A network entity, such as a network entity 105 described with reference to FIGS. 1 and 2, may transmit the DCI message 400 to a UE, such as a UE 115 described with reference to FIGS. 1 and 2. The DCI message 400 may be an example of a non-scheduling downlink DCI message, such as a non-scheduling DCI message 215 described with reference to FIG. 2. The network entity 105 may format the DCI message 400 to indicate BWP changes for multiple CCs. For example, the network entity 105 may repurpose one or more bits (for example, M bits 430) from PDSCH scheduling fields 420 to indicate one or more of the BWP changes.

The DCI message 400 may include a first field indicating a DCI format 405 of the DCI message 400. The DCI format 405 may be an example of a non-scheduling downlink DCI format, such as DCI format 1_1 or DCI format 1_2 that refrains from scheduling a data transmission (for example, a physical downlink shared channel (PDSCH) transmission). A UE 115 receiving the DCI message 400 may determine the DCI format 405 of the DCI message 400 using the first field.

In some examples, the DCI message 400 may include a second field including a carrier indicator 410. For example, if cross-carrier scheduling is configured for a UE 115, the network entity 105 may include the carrier indicator 410 in the DCI message 400 for the UE 115. Additionally, or alternatively, the DCI message 400 may include a third field including a BWP indicator 415. In some implementations, the carrier indicator 410 and the BWP indicator 415 may be associated with the signaling of the DCI message 400.

The DCI message 400 may not schedule a data transmission, such as a PDSCH transmission. Fields that are used for scheduling PDSCH in scheduling DCI formats (for example, PDSCH scheduling fields 420) may be redundant or unused. The network entity 105 may repurpose one or more fields of the PDSCH scheduling fields 420 to instead indicate additional BWP switching information. By decoupling scheduling (such as PDSCH scheduling) and BWP switching for the DCI message 400, a same DCI format and size can be used for either scheduling or multi-CC BWP switching.

The DCI message 400 may include HARQ information 435 (for example, even though the DCI message 400 refrains from scheduling a data transmission). For example, the DCI message 400 may include one or more fields specific to HARQ-ACK transmission, such as a transmit power control (TPC) command field for physical uplink control channel (PUCCH), a PUCCH resource indicator field, a feedback timing indicator field, or some combination thereof indicating the HARQ information 435. The HARQ information 435 may configure—or otherwise indicate—resources and other parameters for HARQ feedback, such that the UE 115 receiving the DCI message 400 may transmit, to the network entity 105, a HARQ-ACK message confirming successful receipt of the DCI message 400 indicating multi-CC BWP switching.

The DCI message 400 may additionally, or alternatively, include cyclic redundancy check (CRC) bits. In some examples, the network entity 105 may scramble the CRC bits 440 using a cell radio network temporary identifier (C-RNTI) or a configured scheduling radio network temporary identifier (CS-RNTI) for the DCI message 400.

Some DCI messages may include fields specific to scheduled PDSCH transmissions. For example, the PDSCH scheduling fields 420 may include a field indicating a frequency domain resource allocation (FDRA) 425, a field indicating a time domain resource allocation (TDRA), a field indicating a modulation and coding scheme (MCS), a field including a new data indicator (NDI), a field indicating a redundancy version (RV), a field indicating a HARQ process number, a field indicating a set of antenna ports, a field indicating demodulation reference signal (DMRS) sequence initialization, or any combination thereof. In some examples (for example, according to an RRC configuration), the PDSCH scheduling fields 420 may additionally, or alternatively, include a field indicating a virtual resource block (VRB) to physical resource block (PRB) mapping, a field including a PRB bundling size indicator, a field including a rate matching indicator, or any combination of these or other PDSCH scheduling fields 420. The network entity 105 may repurpose one or more of these fields to instead indicate multi-CC BWP switching (for example, repurposing a set of M bits 430).

However, one or more of the PDSCH scheduling fields 420 may instead support validation. For example, one or more of the PDSCH scheduling fields 420 may indicate (for example, validate) to a UE 115 that the DCI message 400 is for BWP switching and does not schedule PDSCH. In some examples, the field indicating the FDRA 425 may be used for validation. For example, the network entity 105 may set the field indicating the FDRA 425 to a reserved value, such as all 0 bits for resource allocation (RA) Type 0, all 1 bits for RA Type 1, all 0 bits for a dynamic switch between RA Type 0 and RA Type 1, or some other reserved value. The reserved value may indicate that the DCI message 400 is a non-scheduling DCI for multi-CC BWP switching. Additionally, or alternatively, one or more other fields in the PDSCH scheduling fields 420 may be used for validation. The M bits 430 repurposed for multi-CC BWP switch indications may not include the bits used for validation, such as the bits of the field indicating the FDRA 425.

In some examples, the DCI message 400 may indicate a first BWP switch for a first CC using the carrier indicator 410, the BWP indicator 415, or both. The DCI message 400 may indicate additional BWP switches for one or more other CCs (other than—and in addition to—the first CC) using the M bits 430 repurposed for multi-CC BWP switch indication. In some implementations, if the field including the carrier indicator 410 is present in the DCI message 400, the “first” CC may be the CC indicated by the carrier indicator 410 of this field. Otherwise (for example, if the field including the carrier indicator 410 is not present in the DCI message 400), the “first” CC may be the CC via which the DCI message 400 is communicated. The DCI message 400 may indicate a target BWP for the first CC using the BWP indicator 415. For example, the field including the BWP indicator 415 may indicate a BWP ID. The UE 115 receiving the DCI message 400 may perform a BWP switch to a BWP corresponding to the indicated BWP ID for the first CC if the indicated BWP ID is different than the BWP ID of the current BWP for the first CC. The network entity 105 may indicate one or more additional BWP IDs of one or more target BWPs for other CCs (for example, other than the first CC) using the M bits 430 repurposed from the PDSCH scheduling fields 420.

In some other examples, the DCI message 400 may indicate each of the BWP switches for CCs using the M bits 430 repurposed for multi-CC BWP switch indication. For example, in some implementations, the DCI message 400 may not include a dedicated BWP indicator field for the first CC. Instead, the M bits 430 repurposed from the PDSCH scheduling fields 420 may indicate a BWP ID for the respective target BWPs of each of the multiple CCs, including the first CC. The UE 115 receiving the DCI message 400 may still determine a first CC, for example, according to the carrier indicator 410 or according to the CC via which the DCI message 400 is communicated. The UE 115 may determine a DCI size for the DCI message 400, a bit width for one or more fields of the DCI message 400, or both in accordance with the first CC. However, for BWP switch indication, the first CC may be used the same as the other CCs for the multi-CC BWP switch.

The M bits 430 repurposed from the PDSCH scheduling fields 420 may indicate BWP IDs for respective target BWPs corresponding to a set of CCs for the multi-CC BWP switch. The “set” of CCs may consist of one or more CCs, for a total of L CCs. The set of CCs associated with the M bits 430 may include or may exclude the first CC for BWP switching in accordance with whether the BWP indicator 415 is used to indicate a target BWP for the first CC.

In some examples, the M bits 430 may indicate target BWPs for the set of CCs in accordance with an RRC configuration. For example, a network entity 105 may transmit an RRC message that configures one or more parameters for indicating BWP switches for the set of CCs. The RRC configuration may be specific to a DCI format 405, such that the network entity 105 may configure different parameters for indicating BWP switches for different DCI formats (for example, different non-scheduling DCI formats, such as DCI formats 1_1 and 1_2). For example, for the DCI format 405 of the DCI message 400 communicated via a specific scheduling CC, the network entity 105 may RRC configure a UE 115 with the one or more parameters for indicating BWP IDs for the set of CCs including L CCs with corresponding CC indices i.

In some implementations, the network entity 105 may configure, via RRC signaling, a quantity of bits nᵢ for indicating a BWP ID for each CC i of the set of CCs, such that

$$M = {Σ}_{i = 1}^{L} {n}_{i} .$$

In some examples, nᵢ may be set to a value of 1 or 2 for each CC i to support indicating one of up to two BWP IDs or one of up to four BWP IDs, respectively, for each CC i. As an example, for a set of CCs including five CCs (such that L=5), the RRC signaling may configure n₁=2, n₂=1, n₃=2, n₄=1, and n₅=1, for a total set of M bits 430-a with M=7. The network entity 105 may repurpose seven bits from the PDSCH scheduling fields 420 to indicate the BWP IDs for the five CCs. For example, in accordance with the RRC signaling, the first two bits 445-a may indicate a first BWP ID from up to four supported BWP IDs for a first CC of the set of CCs according to n₁=2. The third bit 445-b may indicate a second BWP ID from up to two supported BWP IDs for a second CC of the set of CCs according to n₂=1. The fourth and fifth bits 445-c may indicate a third BWP ID from up to four supported BWP IDs for a third CC of the set of CCs according to n₃=2. The sixth bit 445-d may indicate a fourth BWP ID from up to two supported BWP IDs for a fourth CC of the set of CCs according to n₄=1, and the seventh bit 445-e may indicate a fifth BWP ID from up to two supported BWP IDs for a fifth CC of the set of CCs according to n₅=1.

In some other implementations, the network entity 105 may configure, via RRC signaling, the BWP IDs that may be indicated for each CC i of the set of CCs. For example, the RRC signaling may configure a quantity of BWP IDs, bᵢ, for each CC i. In some examples, the network entity 105 may use ┌log₂ bᵢ┐ bits to indicate a respective BWP ID for each CC i, such that

$$M = {Σ}_{i = 1}^{L} ⌈ {log}_{2} {b}_{i} ⌉ .$$

As an example, for a set of CCs including five CCs (such that L=5), the RRC signaling may configure three BWP ID options {0,1,2} for CC 1, two BWP ID options {1,2} for CC 2, four BWP ID options {1,2,3,4} for CC 3, two BWP ID options {0,1} for CC 4, and two BWP ID options {2,3} for CC 5. The network entity 105 may repurpose seven bits from the PDSCH scheduling fields 420 to indicate the BWP IDs for the five CCs using the M bits 430-a. In accordance with the RRC signaling, the first two bits 445-a may indicate a first BWP ID from the three BWP ID options {0,1,2} for CC 1 in accordance with b₁=3. The third bit 445-b may indicate a second BWP ID from the two BWP ID options {1,2} for CC 2 in accordance with b₂=2. The fourth and fifth bits 445-c may indicate a third BWP ID from the four BWP ID options {1,2,3,4} for CC 3 in accordance with b₃=4. The sixth bit 445-d may indicate a fourth BWP ID from the two BWP ID options {0,1} for CC 4 in accordance with b₄=2, and the seventh bit 445-e may indicate a fifth BWP ID from the two BWP ID options {2,3} for CC 5 in accordance with b₅=2.

In some other examples, the network entity 105 may use

$$M = ⌈ {log}_{2} {Π}_{i = 1}^{L} {b}_{i} ⌉$$

bits to jointly indicate a combination of BWP IDs from the configured options for each of the CCs of the set of CCs. As an example, for a set of CCs including three CCs (such that L=3), the RRC signaling may configure three BWP ID options {0,1,2} for CC 1, three BWP ID options {1,2,3} for CC 2, and three BWP ID options {1,3,4} for CC 3. The network entity 105 may repurpose five bits from the PDSCH scheduling fields 420 to jointly indicate a combination of three BWP IDs for the three CCs using the M bits 430-b. In accordance with the RRC signaling, the five bits 450 may represent a bit value that uniquely indicates a first BWP ID for CC 1, a second BWP ID for CC 2, and a third BWP ID for CC 3. For example, the bit value {00101} for the five bits 450 may indicate a first BWP ID {2} for CC 1, a second BWP ID {2} for CC 2, and a third BWP ID {1} for CC 3 in accordance with the RRC signaling.

In yet some other implementations, the network entity 105 may configure, via RRC signaling, a list of combinations of BWP IDs for the set of CCs. Each combination supported by the list of combinations may correspond to a codepoint (for example, value) of the M bits 430. The network entity 105 may use M=┌log₂ K┘ bits to indicate one combination from a list that configures K supported combinations of BWP IDs for the L CCs of the set of CCs. Table 1 provides an example set of combinations configured for a set of CCs including three CCs (such that L=3).

TABLE 1
Example Set of Combinations for
Multi-CC BWP Switching Indication

| Value of M | | | |
|---|---|---|---|
| Bits | BWP ID of CC 1 | BWP ID of CC 1 | BWP ID of CC 1 |
| 0 | 0 | 1 | 1 |
| 1 | 0 | 1 | 2 |
| 2 | 0 | 2 | 2 |
| 3 | 1 | 1 | 1 |

. . .

| | | | |
|---|---|---|---|
| 30 | 3 | 3 | 2 |
| 31 | 3 | 3 | 3 |

The network entity 105 may repurpose five bits from the PDSCH scheduling fields 420 to jointly indicate a combination of three BWP IDs for the three CCs using the M bits 430-b in accordance with the RRC signaling configuring 32 supported combinations of BWP IDs, such that K=32 and M=5. The five bits 450 may represent a bit value that maps to a specific combination of BWP IDs according to the RRC configuration. For example, the bit value {11110} for the five bits 450, corresponding to the decimal value 30, may indicate a first BWP ID {3} for CC 1, a second BWP ID {3} for CC 2, and a third BWP ID {2} for CC 3 in accordance with Table 1 configured by the RRC signaling.

In any such implementations, the M bits 430 may indicate uplink BWP switches, downlink BWP switches, or a combination thereof. That is, the BWP switches for the set of CCs may include downlink BWPs, uplink BWPs, or a combination thereof. In some implementations, BWP switching may depend on a duplexing mode for communication. For example, for TDD (such as in an unpaired spectrum), a UE 115 may perform BWP switching for downlink and uplink BWPs with the same BWP ID concurrently (for example, at the same time). The network entity 105 may indicate a target downlink BWP ID to switch both a downlink BWP and a corresponding uplink BWP in TDD operation. Alternatively, for FDD (such as in a paired spectrum), the UE 115 may perform BWP switching for downlink and uplink BWPs independently (for example, at different times). The network entity 105 may indicate a target downlink BWP ID to switch a downlink BWP and may additionally indicate a target uplink BWP ID to switch an uplink BWP in FDD operation.

The network entity 105 may RRC configure a first subset of CCs that support joint BWP ID indications for uplink and downlink BWPs and a second subset of CCs that support separate BWP ID indications for uplink and downlink BWPs. In some examples, the network entity 105 may transmit RRC signaling that explicitly indicates the first subset of CCs and the second subset of CCs. In some other examples, the network entity 105 may transmit RRC signaling that implicitly indicates the first and second subsets of CCs by indicating a first subset of TDD CCs and a second subset of FDD CCs.

For CCs of the first subset, the DCI message 400 may indicate a downlink BWP ID for a respective CC. The UE 115 receiving the DCI message 400 may switch the downlink BWP for the respective CC to the indicated downlink BWP ID and may additionally switch the uplink BWP with the same ID to the indicted downlink BWP ID. For CCs of the second subset, the DCI message 400 may indicate a downlink BWP ID, an uplink BWP ID, or both for a respective CC. The UE 115 receiving the DCI message 400 may switch the downlink BWP for the respective CC to the indicated downlink BWP ID, the uplink BWP for the respective CC to the indicated uplink BWP ID, or both. If the DCI message 400 indicates a BWP switch for a first CC using the field including the BWP indicator 415, and the first CC is part of the second subset of CCs, the BWP indicator 415 in the field may indicate the downlink BWP ID for the first CC. The DCI message 400 may indicate an uplink BWP ID for the first CC using the M bits 430, and the first CC may be included with the second subset of CCs for uplink BWP switching.

For the second subset of CCs, the M bits 430 may indicate whether a target BWP ID is a downlink BWP ID, an uplink BWP ID, or both. In some examples, the repurposed bits of the DCI message 400 may include M₁ bits indicating downlink BWP IDs for the first subset of CCs, M_{2,DL} bits indicating downlink BWP IDs for the second subset of CCs, and M_{2,UL} bits indicating uplink BWP IDs for the second subset of CCs, such that M=M₁+M_{2,DL}+M_{2,UL}.

In some other examples, the repurposed bits of the DCI message 400 may include M₁ bits indicating downlink BWP IDs for the first subset of CCs, one bit (for example, a one bit flag) selecting between downlink BWP IDs and uplink BWP IDs for the second subset of CCs, and M₂ bits indicating either downlink or uplink BWP IDs for the second subset of CCs in accordance with the one bit flag, such that M=M₁+1+M₂.

In yet some other examples, the repurposed bits of the DCI message 400 may include M₁ bits indicating downlink BWP IDs for the first subset of CCs, L₂ bits selecting between downlink BWP IDs and uplink BWP IDs for each CC of the second subset of CCs, and M₂ bits indicating either downlink or uplink BWP IDs for each CC of the second subset of CCs in accordance with a corresponding one bit flag of the L₂ bits, such that M=M₁+L₂+M₂c. The M bits may support BWP switching for L₂ CCs of the second subset.

In some other examples, the repurposed bits of the DCI message 400 may include M₀ bits indicating downlink BWP IDs for the set of CCs (for example, across both the first and second subsets) and M_{2,UL} bits indicating uplink BWP IDs for the second subset of CCs, such that M=M₀+M_{2,UL}.

In yet some other examples, the repurposed bits of the DCI message 400 may jointly indicate a combination of downlink BWP IDs for the first subset, downlink BWP IDs for the second subset, and uplink BWP IDs for the second subset using the M bits 430. For example, RRC signaling may configure a list of supported combinations of downlink BWP IDs for the L₁ CCs in the first subset, downlink BWP IDs for the L₂ CCs in the second subset, and uplink BWP IDs for the L₂ CCs in the second subset. Each combination in the list of supported combinations may correspond to one codepoint (for example, value) of the M bits 430. For example, the RRC signaling may configure a table, similar to Table 1, indicating L₁ downlink BWP IDs, L₂ downlink BWP IDs, and L₂ uplink BWP IDs for each combination.

The DCI message 400 may indicate the BWP IDs in M, M₀, M₁, M_{2,DL}, M_{2,UL}, or any combination thereof using any of the mechanisms described herein. For example, the BWP IDs for the first subset of CCs and the second subset of CCs may be indicated using the same mechanism or different mechanisms in accordance with RRC signaling, the DCI format 405, or both.

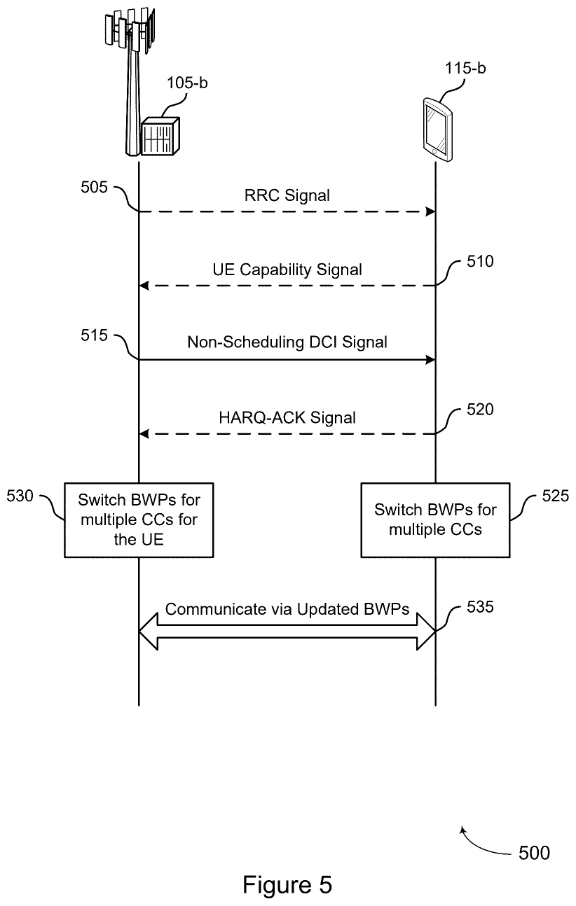

FIG. 5 shows an example of a process flow 500 that supports BWP switching with CA in accordance with one or more aspects of the present disclosure. The process flow 500 may be performed by aspects of the wireless communications system 100 or the wireless communications system 200, as described with reference to FIGS. 1 and 2. For example, a UE 115-b and a network entity 105-b, which may be respective examples of a UE 115 and a network entity 105 as described with reference to FIGS. 1-4, may perform aspects of the process flow 500. In the following description of the process flow 500, operations performed by the UE 115-b and the network entity 105-b may be performed in a different order than is shown. Some operations may be omitted from the process flow 500, and other operations may be added to the process flow 500. Further, although some operations or signaling may be shown to occur at different times for discussion purposes, these operations may occur at the same time. Additionally, or alternatively, other wireless devices may perform aspects of the process flow 500.

In some examples, at 505, the network entity 105-b may transmit an RRC signal that configures one or more parameters for multi-CC BWP switching. For example, the RRC signal may indicate, for a set of CCs, a respective quantity of bits for indicating a target BWP ID for each CC of the set of CCs, a respective set of BWP IDs that can be indicated for each CC of the set of CCs, a set of combinations of BWP IDs that can be indicated for the set of CCs, or some combination thereof. Additionally, or alternatively, the RRC signal may indicate a first subset of CCs supporting shared BWP indication for uplink and downlink BWPs, a second subset of CCs supporting separate BWP indication for uplink and downlink BWPs, or both. The UE 115-b may receive the RRC signal.

In some examples, at 510, the UE 115-b may transmit a UE capability signal that indicates one or more capabilities of the UE 115-b. The network entity 105-b may receive the UE capability signal. In some implementations, the UE capability signal may indicate that the UE 115-b supports multi-CC BWP switching using a single DCI signal (for example, a single non-scheduling downlink DCI message).

At 515, the network entity 105-b may transmit a non-scheduling DCI signal that indicates active BWP switches for multiple respective CCs. For example, the non-scheduling DCI signal may indicate BWP switches for at least two CCs of the UE 115-b. In some examples, a first active BWP switch of the multiple active BWP switches may be associated with an uplink BWP. Additionally, or alternatively, a second active BWP switch of the multiple active BWP switches may be associated with a downlink BWP. The non-scheduling DCI signal may indicate different target BWP IDs for different CCs and may support switching from one non-dormant downlink BWP to a different non-dormant downlink BWP for a CC. The UE 115-b may receive the non-scheduling DCI signal.

In some examples, the non-scheduling DCI signal may further indicate a resource for HARQ-ACK feedback. At 520, the UE 115-b may transmit, via the resource for HARQ-ACK feedback, a HARQ-ACK signal that acknowledges reception of the non-scheduling DCI signal at the UE 115-b. The network entity 105-b may receive the HARQ-ACK signal via the resource for HARQ-ACK feedback.

At 525, the UE 115-b may switch from a first set of active BWPs to a second set of active BWPs in accordance with the non-scheduling DCI signal indicating the active BWP switches for the multiple respective CCs. The UE 115-b may start the BWP switching after reception of the non-scheduling DCI signal or after transmission of the HARQ-ACK signal. Similarly, at 530, the network entity 105-b may switch from the first set of active BWPs to the second set of active BWPs for the UE 115-b in accordance with the non-scheduling DCI signal. The UE 115-b and the network entity 105-b may coordinate BWP switches and align timings for performing the BWP switches.

At 535, the UE 115-b and the network entity 105-b may communicate in accordance with the multiple BWP switches.

The network entity 105-b may transmit the non-scheduling DCI signal via any CC of the set of CCs to indicate BWP switching for multiple CCs. In some examples, the network entity 105-b may apply one or more restrictions for multi-CC BWP switching in accordance with a configuration, UE capabilities, or both. For example, the one or more restrictions may indicate how the DCI indicating multi-CC BWP switching may be transmitted. In some implementations, the UE capability signal transmitted at 510 by the UE 115-b may indicate one or more UE capabilities associated with one or more restrictions, relaxation of one or more restrictions, or both.

In some examples, a first restriction may indicate that, for a specific CC, BWP switching may be indicated by one scheduling CC. A “scheduling” CC may be the CC via which the DCI indicating BWP switching is received. In this context, “scheduling” does not refer to scheduling a data transmission, such as for a “scheduling” DCI. The first restriction may indicate, for the specific CC, the one “scheduling” CC that supports reception of DCI indicating BWP switching for the specific CC. If the UE 115-b indicates support for relaxing the first restriction, the UE 115-b may indicate a threshold quantity of scheduling CCs that may indicate BWP switching for a specific CC.

In some examples, a second restriction may indicate that, for a specific CC, BWP switching may be indicated via a scheduling CC if a carrier indicator field is not present in the DCI or if the carrier indicator field indicates a specific value (such as 0 or another reserved value). If the UE 115-b indicates support for relaxing the second restriction, the UE 115-b may indicate a threshold quantity of carrier indicator field values for the DCI in the scheduling CC that may indicate BWP switching for a specific CC.

In some examples, a third restriction may indicate that, for a specific CC, BWP switching may be indicated via a scheduling CC if the specific CC and the scheduling CC are in the same cell group (for example, the same cell group for dual connectivity (DC) operation or the same PUCCH group for CA operation), in the same band or frequency range, have the same subcarrier spacing (SCS) (for example, between the SCS of the scheduling CC and the SCS of the specific CC before the BWP switch, after the BWP switch, or both), have the same duplex mode (for example, both FDD mode, both TDD mode, or both subband full duplex (SBFD) mode), or any combination thereof. If the UE 115-b indicates support for relaxing one or more aspects of the third restriction, the UE 115-b may indicate a threshold quantity of CCs for which a DCI format may indicate BWP switching (for example, using target BWP IDs).

Additionally, or alternatively, the UE 115-b may indicate whether the specific CC and the scheduling CC may be in different cell groups, in different bands or frequency ranges, have different SCSs, have different duplex modes, or any combination thereof. Additionally, or alternatively, the UE 115-b may indicate whether the multiple CCs for which a same DCI indicates (or can indicate) BWP change or BWP IDs may be in different cell groups, in different bands or frequency ranges, have different SCSs, have different duplex modes, or any combination thereof.

In some implementations, the network entity 105-b may receive the UE capability signal at 510 indicating relaxation of one or more restrictions and may generate and transmit the non-scheduling DCI signal at 515 in accordance with one or more restrictions, one or more relaxations of one or more restrictions according to the UE capability signal, or both.

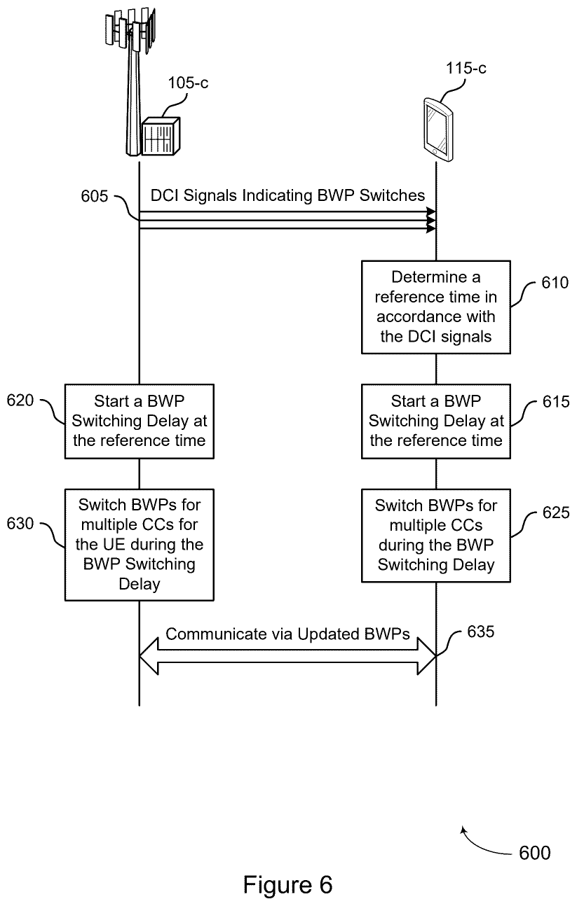

FIG. 6 shows an example of a process flow 600 that supports BWP switching with CA in accordance with one or more aspects of the present disclosure. The process flow 600 may be performed by aspects of the wireless communications system 100 or the wireless communications system 200, as described with reference to FIGS. 1 and 2. For example, a UE 115-c and a network entity 105-c, which may be respective examples of a UE 115 and a network entity 105 as described with reference to FIGS. 1-5, may perform aspects of the process flow 600. In the following description of the process flow 600, operations performed by the UE 115-c and the network entity 105-c may be performed in a different order than is shown. Some operations may be omitted from the process flow 600, and other operations may be added to the process flow 600. Further, although some operations or signaling may be shown to occur at different times for discussion purposes, these operations may occur at the same time. Additionally, or alternatively, other wireless devices may perform aspects of the process flow 600.

At 605, the network entity 105-c may transmit multiple DCI signals that indicate a set of active BWP switches for multiple sets of CCs. The multiple DCI signals (for example, multiple DCI messages) may further indicate one or more resources for HARQ-ACK feedback. The “sets” of CCs may include one or more CCs. For example, the multiple DCI signals indicating BWP switches for multiple sets of CCs may be an example of two or more DCI signals indicating BWP switches for two or more CCs at the UE 115-c. The DCI signals may correspond to any DCI format that supports indicating BWP switching. For example, one or more of the DCI signals may be a non-scheduling downlink DCI signal that indicates multi-CC BWP switching. The UE 115-c may receive the multiple DCI signals.

At 610, the UE 115-c may determine a reference time in accordance with the multiple DCI signals. The reference time may define a time at which to start a BWP switching delay for the set of active BWP switches for the multiple sets of CCs. The reference time may be associated with at least one resource of the one or more resources for HARQ-ACK feedback indicated by the multiple DCI signals. For example, if the multiple DCI signals indicate a same resource in the time domain for the HARQ-ACK feedback, the reference time may correspond to this same resource. If the multiple DCI signals indicate a set of multiple resources in the time domain for the HARQ-ACK feedback, the reference time may correspond to one of these time domain resources in accordance with a resource selection rule. For example, the UE 115-c may determine an earliest time domain resource for the HARQ-ACK feedback or a latest time domain resource for the HARQ-ACK feedback as the reference time.

At 615, the UE 115-c may start the BWP switching delay at the reference time. The BWP switching delay may depend on a quantity of CCs in the multiple sets of CCs, a UE capability of the UE 115-c, or both. At 625, the UE 115-c may perform the active BWP switches for the multiple sets of CCs during the BWP switching delay. The network entity 105-c may coordinate BWP switching with the UE 115-c. For example, at 620, the network entity 105-c may also start the BWP switching delay at the reference time. At 630, the network entity 105-c may perform the active BWP switches for the UE 115-c for the multiple sets of CCs during the BWP switching delay.

At 635, the UE 115-c and the network entity 105-c may communicate in accordance with the active BWP switches after the BWP switching delay. For example, the UE 115-c and the network entity 105-c may complete the BWP switches to the target BWPs for the multiple sets of CCs by the expiration of the BWP switching delay, such that the UE 115-c and the network entity 105-c may communicate via one or more of the target BWPs.

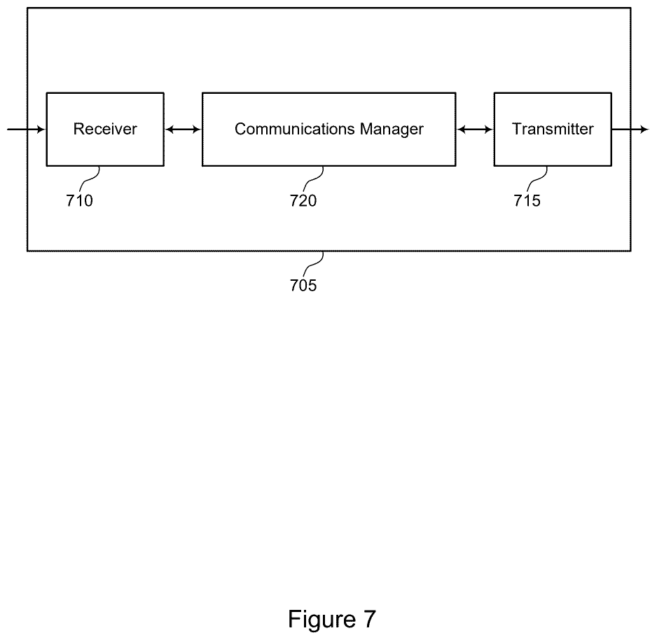

FIG. 7 shows a block diagram of a device 705 that supports BWP switching with CA in accordance with one or more aspects of the present disclosure. The device 705 may be an example of aspects of a UE 115. The device 705 may include a receiver 710, a transmitter 715, and a communications manager 720. The device 705, or one or more components of the device 705 (for example, the receiver 710, the transmitter 715, the communications manager 720), may include at least one processor, which may be coupled with at least one memory, to, individually or collectively, support or enable the described techniques. Each of these components may be in communication with one another (for example, via one or more buses).

The receiver 710 may provide a means for receiving information such as packets, user data, control information, or any combination thereof associated with various information channels (for example, control channels, data channels, information channels related to BWP switching with CA). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (for example, control channels, data channels, information channels related to BWP switching with CA). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of BWP switching with CA. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (for example, in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

Additionally, or alternatively, the communications manager 720, the receiver 710, the transmitter 715, or various combinations or components thereof may be implemented in code (for example, as communications management software or firmware) executed by at least one processor (for example, referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 720 may be configured to perform various operations (for example, receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations.

The communications manager 720 may support wireless communications in accordance with examples as disclosed herein. For example, the communications manager 720 is capable of, configured to, or operable to support a means for receiving a non-scheduling DCI signal that indicates a set of multiple active BWP switches for a set of multiple respective CCs, a first active BWP switch of the set of multiple active BWP switches being associated with an uplink BWP. The communications manager 720 is capable of, configured to, or operable to support a means for communicating in accordance with the set of multiple active BWP switches.

Additionally, or alternatively, the communications manager 720 may support wireless communications in accordance with examples as disclosed herein. For example, the communications manager 720 is capable of, configured to, or operable to support a means for receiving a set of multiple DCI signals that indicate a set of multiple active BWP switches for a set of multiple respective sets of CCs and one or more resources for HARQ-ACK feedback. The communications manager 720 is capable of, configured to, or operable to support a means for communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

By including or configuring the communications manager 720, the device 705 (for example, at least one processor controlling or otherwise coupled with the receiver 710, the transmitter 715, the communications manager 720, or a combination thereof) may support techniques for reduced power consumption and more efficient utilization of communication resources.

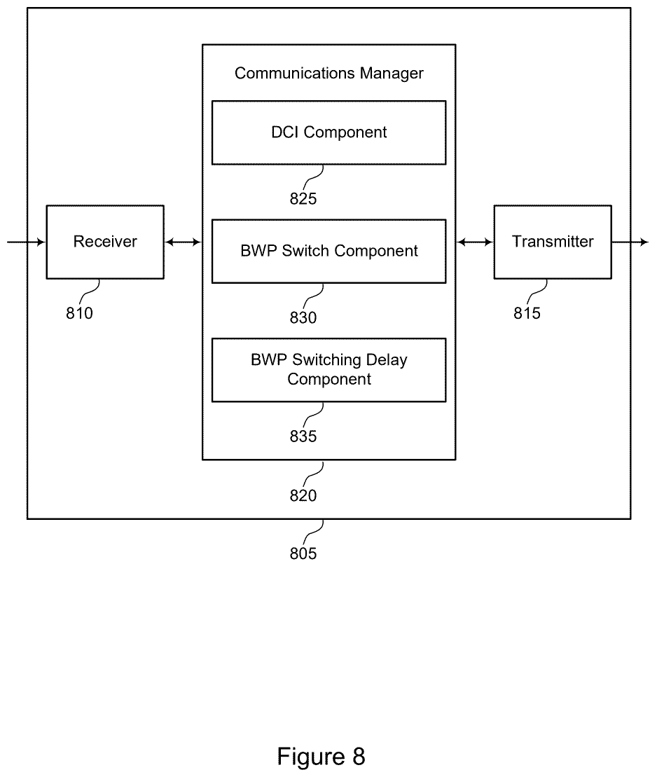

FIG. 8 shows a block diagram of a device 805 that supports BWP switching with CA in accordance with one or more aspects of the present disclosure. The device 805 may be an example of aspects of a device 705 or a UE 115. The device 805 may include a receiver 810, a transmitter 815, and a communications manager 820. The device 805, or one of more components of the device 805 (for example, the receiver 810, the transmitter 815, the communications manager 820), may include at least one processor, which may be coupled with at least one memory, to support the described techniques. Each of these components may be in communication with one another (for example, via one or more buses).

The receiver 810 may provide a means for receiving information such as packets, user data, control information, or any combination thereof associated with various information channels (for example, control channels, data channels, information channels related to BWP switching with CA). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (for example, control channels, data channels, information channels related to BWP switching with CA). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of BWP switching with CA. For example, the communications manager 820 may include a DCI component 825, a BWP switch component 830, a BWP switching delay component 835, or any combination thereof. The communications manager 820 may be an example of aspects of a communications manager 720. In some examples, the communications manager 820, or various components thereof, may be configured to perform various operations (for example, receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations.

The communications manager 820 may support wireless communications in accordance with examples as disclosed herein. The DCI component 825 is capable of, configured to, or operable to support a means for receiving a non-scheduling DCI signal that indicates a set of multiple active BWP switches for a set of multiple respective CCs, a first active BWP switch of the set of multiple active BWP switches being associated with an uplink BWP. The BWP switch component 830 is capable of, configured to, or operable to support a means for communicating in accordance with the set of multiple active BWP switches.

Additionally, or alternatively, the communications manager 820 may support wireless communications in accordance with examples as disclosed herein. The DCI component 825 is capable of, configured to, or operable to support a means for receiving a set of multiple DCI signals that indicate a set of multiple active BWP switches for a set of multiple respective sets of CCs and one or more resources for HARQ-ACK feedback. The BWP switching delay component 835 is capable of, configured to, or operable to support a means for communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

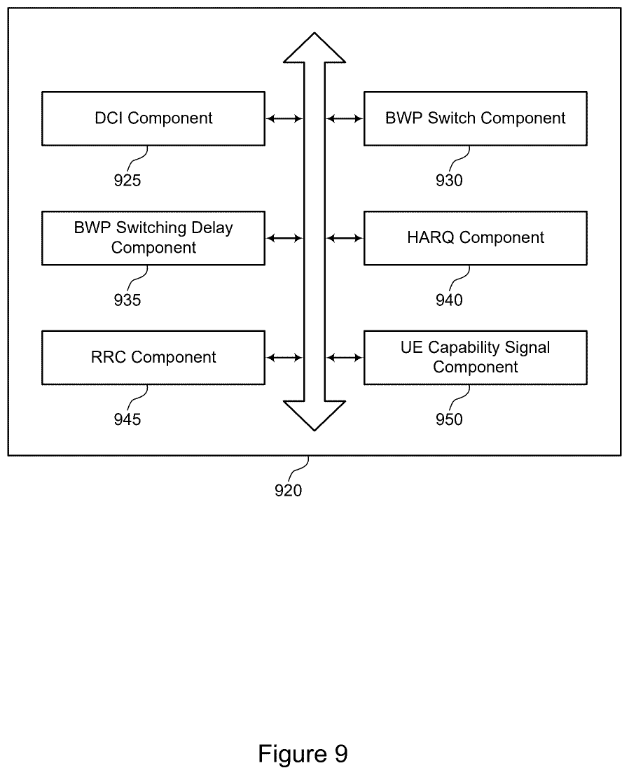

FIG. 9 shows a block diagram of a communications manager 920 that supports BWP switching with CA in accordance with one or more aspects of the present disclosure. The communications manager 920, or various components thereof, may be an example of means for performing various aspects of BWP switching with CA. For example, the communications manager 920 may include a DCI component 925, a BWP switch component 930, a BWP switching delay component 935, a HARQ component 940, an RRC component 945, a UE capability signal component 950, or any combination thereof. Each of these components, or components or subcomponents thereof (for example, one or more processors, one or more memories), may communicate, directly or indirectly, with one another (for example, via one or more buses).

The communications manager 920 may support wireless communications in accordance with examples as disclosed herein. The DCI component 925 is capable of, configured to, or operable to support a means for receiving a non-scheduling DCI signal that indicates a set of multiple active BWP switches for a set of multiple respective CCs, a first active BWP switch of the set of multiple active BWP switches being associated with an uplink BWP. The BWP switch component 930 is capable of, configured to, or operable to support a means for communicating in accordance with the set of multiple active BWP switches.

In some examples, the non-scheduling DCI signal further indicates a resource for HARQ-ACK feedback, and the HARQ component 940 is capable of, configured to, or operable to support a means for transmitting, via the resource for HARQ-ACK feedback, a HARQ-ACK signal that acknowledges reception of the non-scheduling DCI signal. In some examples, the BWP switch component 930 is capable of, configured to, or operable to support a means for switching from a first set of multiple active BWPs to a second set of multiple active BWPs in accordance with the set of multiple active BWP switches after the HARQ-ACK signal that acknowledges the reception of the non-scheduling DCI signal is transmitted.

In some examples, the BWP switch component 930 is capable of, configured to, or operable to support a means for switching from a first set of multiple active BWPs to a second set of multiple active BWPs in accordance with the set of multiple active BWP switches after the non-scheduling DCI signal is received.

In some examples, one or more fields of the non-scheduling DCI signal are set to one or more reserved values to indicate that the non-scheduling DCI signal indicates multi-CC BWP switching. In some examples, the one or more fields of the non-scheduling DCI signal set to the one or more reserved values include an FDRA field.

In some examples, a set of bits from one or more fields of the non-scheduling DCI signal indicates one or more IDs of one or more respective target BWPs for one or more respective CCs of the set of multiple respective CCs. In some examples, the one or more fields of the non-scheduling DCI signal include one or more of a TDRA field, an MCS field, an NDI field, an RV field, a HARQ process number field, an antenna ports field, a DMRS sequence initialization field, a VRB-to-PRB mapping field, a PRB bundling size indicator field, or a rate matching indicator field.

In some examples, the RRC component 945 is capable of, configured to, or operable to support a means for receiving an RRC signal that indicates a first subset of CCs and a second subset of CCs. The non-scheduling DCI signal may indicate a single target BWP ID for both a first uplink BWP and a first downlink BWP corresponding to a same first CC of the first subset of CCs and separate target BWP IDs for a second uplink BWP and a second downlink BWP corresponding to a same second CC of the second subset of CCs.

In some examples, a first subset of the set of bits indicates one or more first downlink BWP IDs for the first subset of CCs, a second subset of the set of bits indicates one or more second downlink BWP IDs for downlink CCs of the second subset of CCs, and a third subset of the set of bits indicates one or more uplink BWP IDs for uplink CCs of the second subset of CCs. In some other examples, a first subset of the set of bits indicates one or more downlink BWP IDs for the first subset of CCs, a one bit flag of the set of bits indicates either uplink or downlink for the second subset of CCs, and a second subset of the set of bits indicates one or more uplink or downlink BWP IDs for the second subset of CCs in accordance with the one bit flag. In some other examples, a first subset of the set of bits indicates one or more downlink BWP IDs for the first subset of CCs, a set of one bit flags of the set of bits indicates either uplink or downlink respectively for each CC of the second subset of CCs, and a second subset of the set of bits indicates one or more uplink or downlink BWP IDs for the second subset of CCs in accordance with the set of one bit flags. In some other examples, a first subset of the set of bits indicates one or more downlink BWP IDs for the first subset of CCs and for downlink CCs of the second subset of CCs and a second subset of the set of bits indicates one or more uplink BWP IDs for uplink CCs of the second subset of CCs. In some other examples, the set of bits jointly indicates a combination of one or more first downlink BWP IDs for the first subset of CCs, one or more second downlink BWP IDs for downlink CCs of the second subset of CCs, and one or more uplink BWP IDs for uplink CCs of the second subset of CCs.

In some examples, the first subset of CCs corresponds to TDD CCs and the second subset of CCs corresponds to FDD CCs.

In some examples, the non-scheduling DCI signal further indicates a first CC in accordance with one of a carrier indicator field of the non-scheduling DCI signal or the non-scheduling DCI signal being received via the first CC. In some examples, a BWP indicator field of the non-scheduling DCI signal indicates an ID of a target BWP for the first CC.

In some examples, the RRC component 945 is capable of, configured to, or operable to support a means for receiving an RRC signal that configures, for a set of CCs, one or more of a respective quantity of bits for indicating an identifier of a target BWP for each CC of the set of CCs, a respective set of BWP IDs that can be indicated for each CC of the set of CCs, or a set of combinations of BWP IDs that can be indicated for the set of CCs. The non-scheduling DCI signal may indicate the set of multiple active BWP switches for the set of multiple respective CCs in accordance with the RRC signal. In some examples, the set of CCs includes one of the set of multiple respective CCs or a subset of the set of multiple respective CCs.

In some examples, the UE capability signal component 950 is capable of, configured to, or operable to support a means for transmitting a UE capability signal that indicates a relaxation of a restriction for the non-scheduling DCI signal.

In some examples, the non-scheduling DCI signal is received via a scheduling CC for the set of multiple respective CCs. In some examples, the UE capability signal component 950 is capable of, configured to, or operable to support a means for transmitting a UE capability signal that indicates a quantity of scheduling CCs that can indicate BWP switching for a CC. In some examples, the non-scheduling DCI signal includes one of a reserved value for a carrier indicator field or no value for the carrier indicator field. In some such examples, the UE capability signal component 950 is capable of, configured to, or operable to support a means for transmitting a UE capability signal that indicates a quantity of carrier indicator field values of the non-scheduling DCI signal that can indicate the BWP switching for the set of multiple respective CCs. In some examples, the scheduling CC and each CC of the set of multiple respective CCs are associated with one or more of a same cell group, a same frequency band, a same frequency range, a same SCS, or a same duplex mode. In some such examples, the UE capability signal component 950 is capable of, configured to, or operable to support a means for transmitting a UE capability signal that indicates one or more of a quantity of CCs supported for the set of multiple active BWP switches, first support for the set of multiple respective CCs to be associated with different cell groups, second support for the set of multiple respective CCs to be associated with different frequency bands, third support for the set of multiple respective CCs to be associated with different frequency ranges, fourth support for the set of multiple respective CCs to be associated with different SCSs, or fifth support for the set of multiple respective CCs to be associated with different duplex modes.

In some examples, a second active BWP switch of the set of multiple active bandwidth part switches is associated with a downlink BWP. In some examples, the second active BWP switch indicates to switch from a first non-dormant downlink BWP to a second non-dormant BWP.

In some examples, the non-scheduling DCI signal includes one or more CRC bits that are scrambled in accordance with one of a C-RNTI or a CS-RNTI. The non-scheduling DCI signal refrains from scheduling a data transmission for the UE.

Additionally, or alternatively, the communications manager 920 may support wireless communications in accordance with examples as disclosed herein. In some examples, the DCI component 925 is capable of, configured to, or operable to support a means for receiving a set of multiple DCI signals that indicate a set of multiple active BWP switches for a set of multiple respective sets of CCs and one or more resources for HARQ-ACK feedback. The BWP switching delay component 935 is capable of, configured to, or operable to support a means for communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

In some examples, the BWP switching delay component 935 is capable of, configured to, or operable to support a means for starting the BWP switching delay at the reference time. The communicating may occur after a duration of the BWP switching delay.

In some examples, the set of multiple DCI signals indicate a same resource for the HARQ-ACK feedback. In some such examples, the reference time corresponds to a time domain resource of the same resource for the HARQ-ACK feedback.

In some other examples, the set of multiple DCI signals indicate a set of multiple resources for the HARQ-ACK feedback. In some such examples, the reference time corresponds to a first time domain resource of the set of multiple resources for the HARQ-ACK feedback that occurs earliest or latest in time.

In some examples, a set of CCs consists of one or more CCs.

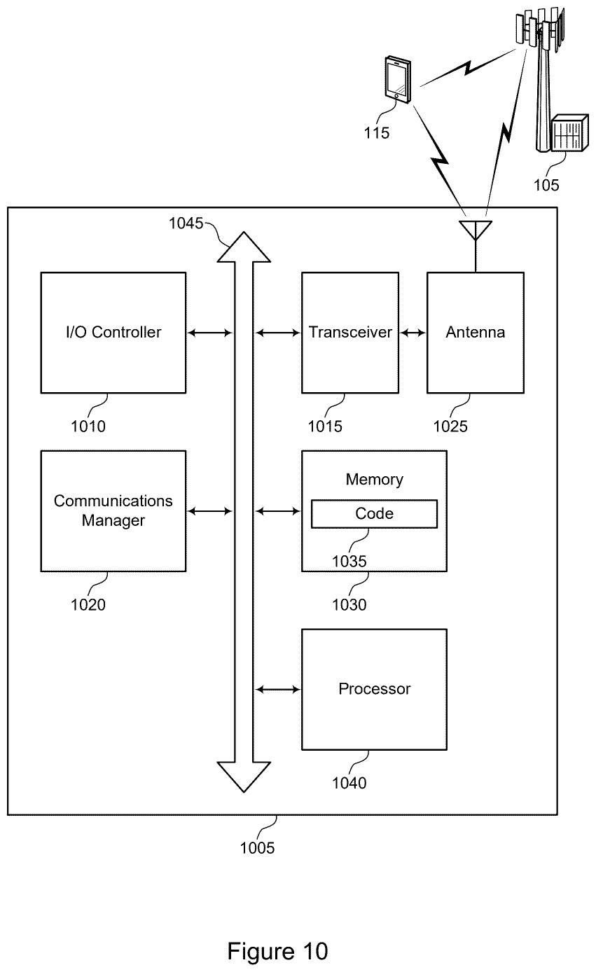

FIG. 10 shows a diagram of a system including a device 1005 that supports BWP switching with CA in accordance with one or more aspects of the present disclosure. The device 1005 may be an example of or include components of a device 705, a device 805, or a UE 115. The device 1005 may communicate (for example, wirelessly) with one or more other devices (for example, network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (for example, operatively, communicatively, functionally, electronically, electrically) via one or more buses (for example, a bus 1045).

The I/O controller 1010 may manage input and output signals for the device 1005. The I/O controller 1010 may also manage peripherals not integrated into the device 1005. In some examples, the I/O controller 1010 may represent a physical connection or port to an external peripheral. In some examples, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some examples, the I/O controller 1010 may be implemented as part of one or more processors, such as the at least one processor 1040. In some examples, a user may interact with the device 1005 via the I/O controller 1010 or via hardware components controlled by the I/O controller 1010.

In some examples, the device 1005 may include a single antenna. However, in some other examples, the device 1005 may have more than one antenna, which may be capable of concurrently transmitting or receiving multiple wireless transmissions. The transceiver 1015 may communicate bi-directionally via the one or more antennas 1025 using wired or wireless links. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some examples, the code 1035 may not be directly executable by the at least one processor 1040 but may cause a computer (for example, when compiled and executed) to perform functions described herein. In some examples, the at least one memory 1030 may include, among other things, a basic I/O system (BIOS) which may control basic hardware or software operation such as the interaction with peripheral components or devices.

The at least one processor 1040 may include one or more intelligent hardware devices (for example, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some examples, the at least one processor 1040 may be configured to operate a memory array using a memory controller. In some other examples, a memory controller may be integrated into the at least one processor 1040. The at least one processor 1040 may be configured to execute computer-readable instructions stored in a memory (for example, the at least one memory 1030) to cause the device 1005 to perform various functions (for example, functions or tasks supporting BWP switching with CA). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, being “configured to,” being “configurable to,” and being “operable to” may be used interchangeably and may be associated with a capability, when executing code 1035 (for example, processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a non-scheduling DCI signal that indicates a set of multiple active BWP switches for a set of multiple respective CCs, a first active BWP switch of the set of multiple active BWP switches being associated with an uplink BWP. The communications manager 1020 is capable of, configured to, or operable to support a means for communicating in accordance with the set of multiple active BWP switches. In some examples, the communications manager 1020 can be implemented, at least in part, by one or both of a modem and at least one processor 1040.

Additionally, or alternatively, the communications manager 1020 may support wireless communications in accordance with examples as disclosed herein. For example, the communications manager 1020 is capable of, configured to, or operable to support a means for receiving a set of multiple DCI signals that indicate: a set of multiple active BWP switches for a set of multiple respective sets of CCs; and one or more resources for HARQ-ACK feedback. The communications manager 1020 is capable of, configured to, or operable to support a means for communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

By including or configuring the communications manager 1020, the device 1005 may support techniques for improved communication reliability, reduced latency, more efficient utilization of communication resources, and improved coordination between devices.

In some examples, the communications manager 1020 may be configured to perform various operations (for example, receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of BWP switching with CA, or the at least one processor 1040 and the at least one memory 1030 may be otherwise configured to, individually or collectively, perform or support such operations.

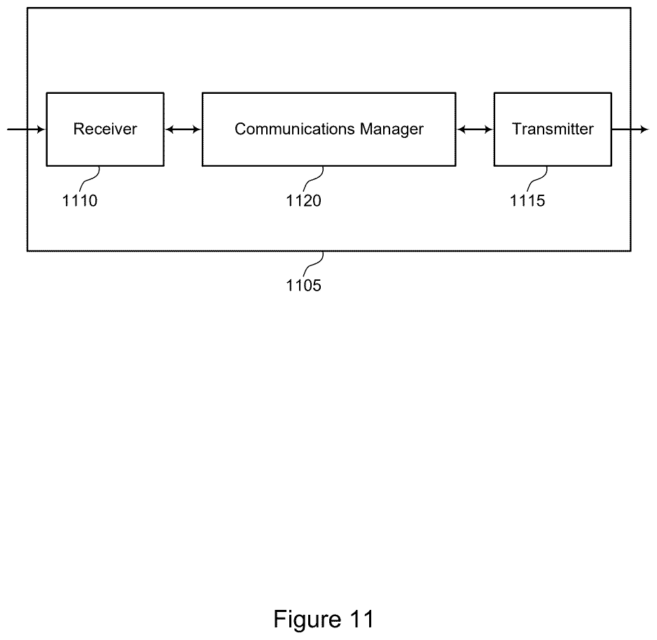

FIG. 11 shows a block diagram of a device 1105 that supports BWP switching with CA in accordance with one or more aspects of the present disclosure. The device 1105 may be an example of aspects of a network entity 105. The device 1105 may include a receiver 1110, a transmitter 1115, and a communications manager 1120. The device 1105, or one or more components of the device 1105 (for example, the receiver 1110, the transmitter 1115, the communications manager 1120), may include at least one processor, which may be coupled with at least one memory, to, individually or collectively, support or enable the described techniques. Each of these components may be in communication with one another (for example, via one or more buses).

The receiver 1110 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (for example, electrical, fiber optic) interfaces, wireless interfaces, or any combination thereof.

The transmitter 1115 may provide a means for outputting (for example, transmitting, providing, conveying, sending) information generated by other components of the device 1105. For example, the transmitter 1115 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (for example, electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of BWP switching with CA. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (for example, in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

Additionally, or alternatively, the communications manager 1120, the receiver 1110, the transmitter 1115, or various combinations or components thereof may be implemented in code (for example, as communications management software or firmware) executed by at least one processor (for example, referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 1120 may be configured to perform various operations (for example, receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations.

The communications manager 1120 may support wireless communications in accordance with examples as disclosed herein. For example, the communications manager 1120 is capable of, configured to, or operable to support a means for transmitting a non-scheduling DCI signal that indicates a set of multiple active BWP switches for a set of multiple respective CCs, a first active BWP switch of the set of multiple active BWP switches being associated with an uplink BWP. The communications manager 1120 is capable of, configured to, or operable to support a means for communicating in accordance with the set of multiple active BWP switches.

Additionally, or alternatively, the communications manager 1120 may support wireless communications in accordance with examples as disclosed herein. For example, the communications manager 1120 is capable of, configured to, or operable to support a means for transmitting a set of multiple DCI signals that indicate a set of multiple active BWP switches for a set of multiple respective sets of CCs and one or more resources for HARQ-ACK feedback. The communications manager 1120 is capable of, configured to, or operable to support a means for communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

By including or configuring the communications manager 1120, the device 1105 (for example, at least one processor controlling or otherwise coupled with the receiver 1110, the transmitter 1115, the communications manager 1120, or a combination thereof) may support techniques for reduced processing, reduced power consumption, and more efficient utilization of communication resources.

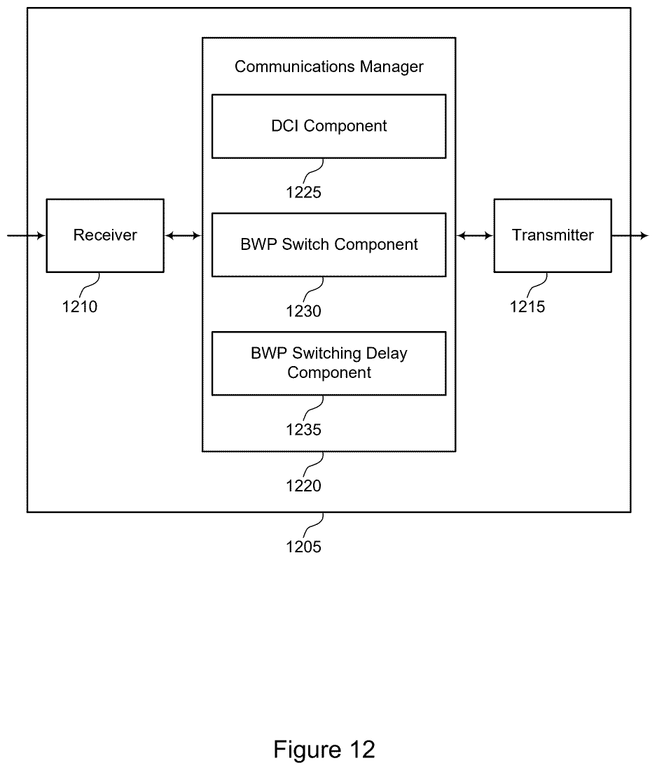

FIG. 12 shows a block diagram of a device 1205 that supports BWP switching with CA in accordance with one or more aspects of the present disclosure. The device 1205 may be an example of aspects of a device 1105 or a network entity 105. The device 1205 may include a receiver 1210, a transmitter 1215, and a communications manager 1220. The device 1205, or one of more components of the device 1205 (for example, the receiver 1210, the transmitter 1215, the communications manager 1220), may include at least one processor, which may be coupled with at least one memory, to support the described techniques. Each of these components may be in communication with one another (for example, via one or more buses).

The receiver 1210 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (for example, electrical, fiber optic) interfaces, wireless interfaces, or any combination thereof.

The transmitter 1215 may provide a means for outputting (for example, transmitting, providing, conveying, sending) information generated by other components of the device 1205. For example, the transmitter 1215 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (for example, electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of BWP switching with CA. For example, the communications manager 1220 may include a DCI component 1225, a BWP switch component 1230, a BWP switching delay component 1235, or any combination thereof. The communications manager 1220 may be an example of aspects of a communications manager 1120. In some examples, the communications manager 1220, or various components thereof, may be configured to perform various operations (for example, receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations.

The communications manager 1220 may support wireless communications in accordance with examples as disclosed herein. The DCI component 1225 is capable of, configured to, or operable to support a means for transmitting a non-scheduling DCI signal that indicates a set of multiple active BWP switches for a set of multiple respective CCs, a first active BWP switch of the set of multiple active BWP switches being associated with an uplink BWP. The BWP switch component 1230 is capable of, configured to, or operable to support a means for communicating in accordance with the set of multiple active BWP switches.

Additionally, or alternatively, the communications manager 1220 may support wireless communications in accordance with examples as disclosed herein. The DCI component 1225 is capable of, configured to, or operable to support a means for transmitting a set of multiple DCI signals that indicate a set of multiple active BWP switches for a set of multiple respective sets of CCs and one or more resources for HARQ-ACK feedback. The BWP switching delay component 1235 is capable of, configured to, or operable to support a means for communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

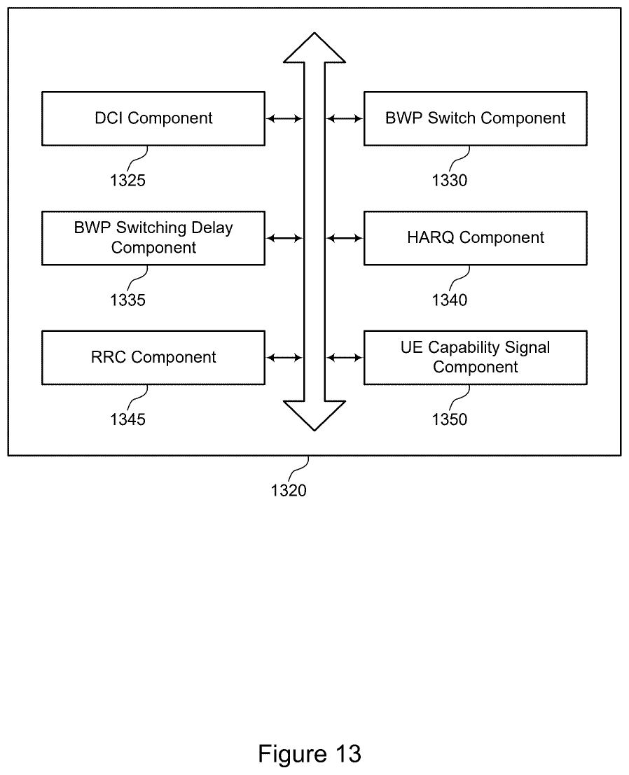

FIG. 13 shows a block diagram of a communications manager 1320 that supports BWP switching with CA in accordance with one or more aspects of the present disclosure. The communications manager 1320, or various components thereof, may be an example of means for performing various aspects of BWP switching with CA. For example, the communications manager 1320 may include a DCI component 1325, a BWP switch component 1330, a BWP switching delay component 1335, a HARQ component 1340, an RRC component 1345, a UE capability signal component 1350, or any combination thereof. Each of these components, or components or subcomponents thereof (for example, one or more processors, one or more memories), may communicate, directly or indirectly, with one another (for example, via one or more buses). The communications may include communications within a protocol layer of a protocol stack, communications associated with a logical channel of a protocol stack (for example, between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The DCI component 1325 is capable of, configured to, or operable to support a means for transmitting a non-scheduling DCI signal that indicates a set of multiple active BWP switches for a set of multiple respective CCs, a first active BWP switch of the set of multiple active BWP switches being associated with an uplink BWP. The BWP switch component 1330 is capable of, configured to, or operable to support a means for communicating in accordance with the set of multiple active BWP switches.

In some examples, the non-scheduling DCI signal further indicates a resource for HARQ-ACK feedback, and the HARQ component 1340 is capable of, configured to, or operable to support a means for receiving, via the resource for HARQ-ACK feedback, a HARQ-ACK signal that acknowledges reception of the non-scheduling DCI signal at a UE.

In some examples, one or more fields of the non-scheduling DCI signal are set to one or more reserved values to indicate that the non-scheduling DCI signal indicates multi-CC BWP switching. In some examples, the one or more fields of the non-scheduling DCI signal set to the one or more reserved values include an FDRA field.

In some examples, a set of bits from one or more fields of the non-scheduling DCI signal indicates one or more IDs of one or more respective target BWPs for one or more respective CCs of the set of multiple respective CCs. In some examples, the one or more fields of the non-scheduling DCI signal include one or more of a TDRA field, an MCS field, an NDI field, an RV field, a HARQ process number field, an antenna ports field, a DMRS sequence initialization field, a VRB-to-PRB mapping field, a PRB bundling size indicator field, or a rate matching indicator field.

In some examples, the RRC component 1345 is capable of, configured to, or operable to support a means for transmitting an RRC signal that indicates a first subset of CCs and a second subset of CCs. The non-scheduling DCI signal may indicate: a single target BWP ID for both a first uplink BWP and a first downlink BWP corresponding to a same first CC of the first subset of CCs, and separate target BWP IDs for a second uplink BWP and a second downlink BWP corresponding to a same second CC of the second subset of CCs.

In some examples, a first subset of the set of bits indicates one or more first downlink BWP IDs for the first subset of CCs, a second subset of the set of bits indicates one or more second downlink BWP IDs for downlink CCs of the second subset of CCs, and a third subset of the set of bits indicates one or more uplink BWP IDs for uplink CCs of the second subset of CCs. In some other examples, a first subset of the set of bits indicates one or more downlink BWP IDs for the first subset of CCs, a one bit flag of the set of bits indicates either uplink or downlink for the second subset of CCs, and a second subset of the set of bits indicates one or more uplink or downlink BWP IDs for the second subset of CCs in accordance with the one bit flag. In some other examples, a first subset of the set of bits indicates one or more downlink BWP IDs for the first subset of CCs, a set of one bit flags of the set of bits indicates either uplink or downlink respectively for each CC of the second subset of CCs, and a second subset of the set of bits indicates one or more uplink or downlink BWP IDs for the second subset of CCs in accordance with the set of one bit flags. In some other examples, a first subset of the set of bits indicates one or more downlink BWP IDs for the first subset of CCs and for downlink CCs of the second subset of CCs and a second subset of the set of bits indicates one or more uplink BWP IDs for uplink CCs of the second subset of CCs. In some other examples, the set of bits jointly indicates a combination of one or more first downlink BWP IDs for the first subset of CCs, one or more second downlink BWP IDs for downlink CCs of the second subset of CCs, and one or more uplink BWP IDs for uplink CCs of the second subset of CCs.

In some examples, the first subset of CCs corresponds to TDD CCs and the second subset of CCs corresponds to FDD CCs.

In some examples, the non-scheduling DCI signal further indicates a first CC in accordance with one of a carrier indicator field of the non-scheduling DCI signal or the non-scheduling DCI signal being transmitted via the first CC. In some such examples, a BWP indicator field of the non-scheduling DCI signal indicates an ID of a target BWP for the first CC.

In some examples, the RRC component 1345 is capable of, configured to, or operable to support a means for transmitting an RRC signal that configures, for a set of CCs, one or more of a respective quantity of bits for indicating an ID of a target BWP for each CC of the set of CCs, a respective set of BWP IDs that can be indicated for each CC of the set of CCs, or a set of combinations of BWP IDs that can be indicated for the set of CCs. The non-scheduling DCI signal may indicate the set of multiple active BWP switches for the set of multiple respective CCs in accordance with RRC signal. In some examples, the set of CCs includes one of the set of multiple respective CCs or a subset of the set of multiple respective CCs.

In some examples, the UE capability signal component 1350 is capable of, configured to, or operable to support a means for receiving a UE capability signal for a UE that indicates a relaxation of a restriction for the non-scheduling DCI signal.

In some examples, the non-scheduling DCI signal is transmitted via a scheduling CC for the set of multiple respective CCs. In some examples, the UE capability signal component 1350 is capable of, configured to, or operable to support a means for receiving a UE capability signal for a UE that indicates a quantity of scheduling CCs that can indicate BWP switching for a CC.

In some examples, the non-scheduling DCI signal includes one of a reserved value for a carrier indicator field or no value for the carrier indicator field. In some examples, the UE capability signal component 1350 is capable of, configured to, or operable to support a means for receiving a UE capability signal for a UE that indicates a quantity of carrier indicator field values of the non-scheduling DCI signal that can indicate the BWP switching for the set of multiple respective CCs.

In some examples, the scheduling CC and each CC of the set of multiple respective CCs are associated with one or more of a same cell group, a same frequency band, a same frequency range, a same SCS, or a same duplex mode. In some examples, the UE capability signal component 1350 is capable of, configured to, or operable to support a means for receiving a UE capability signal for a UE that indicates one or more of a quantity of CCs supported for the set of multiple active BWP switches, first support for the set of multiple respective CCs to be associated with different cell groups, second support for the set of multiple respective CCs to be associated with different frequency bands, third support for the set of multiple respective CCs to be associated with different frequency ranges, fourth support for the set of multiple respective CCs to be associated with different SCSs, or fifth support for the set of multiple respective CCs to be associated with different duplex modes.

In some examples, a second active BWP switch of the set of multiple active BWP switches is associated with a downlink BWP. In some examples, the second active BWP switch indicates to switch from a first non-dormant downlink BWP to a second non-dormant BWP.

In some examples, the non-scheduling DCI signal includes one or more CRC bits that are scrambled in accordance with one of a C-RNTI or a CS-RNTI. The non-scheduling DCI signal refrains from scheduling a data transmission for the UE.

Additionally, or alternatively, the communications manager 1320 may support wireless communications in accordance with examples as disclosed herein. In some examples, the DCI component 1325 is capable of, configured to, or operable to support a means for transmitting a set of multiple DCI signals that indicate a set of multiple active BWP switches for a set of multiple respective sets of CCs and one or more resources for HARQ-ACK feedback. The BWP switching delay component 1335 is capable of, configured to, or operable to support a means for communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

In some examples, the BWP switching delay component 1335 is capable of, configured to, or operable to support a means for starting the BWP switching delay at the reference time. The communicating may occur after a duration of the BWP switching delay.

In some examples, the set of multiple DCI signals indicate a same resource for the HARQ-ACK feedback. In some such examples, the reference time corresponds to a time domain resource of the same resource for the HARQ-ACK feedback.

In some other examples, the set of multiple DCI signals indicate a set of multiple resources for the HARQ-ACK feedback. In some such examples, the reference time corresponds to a first time domain resource of the set of multiple resources for the HARQ-ACK feedback that occurs earliest or latest in time.

In some examples, a set of CCs consists of one or more CCs.

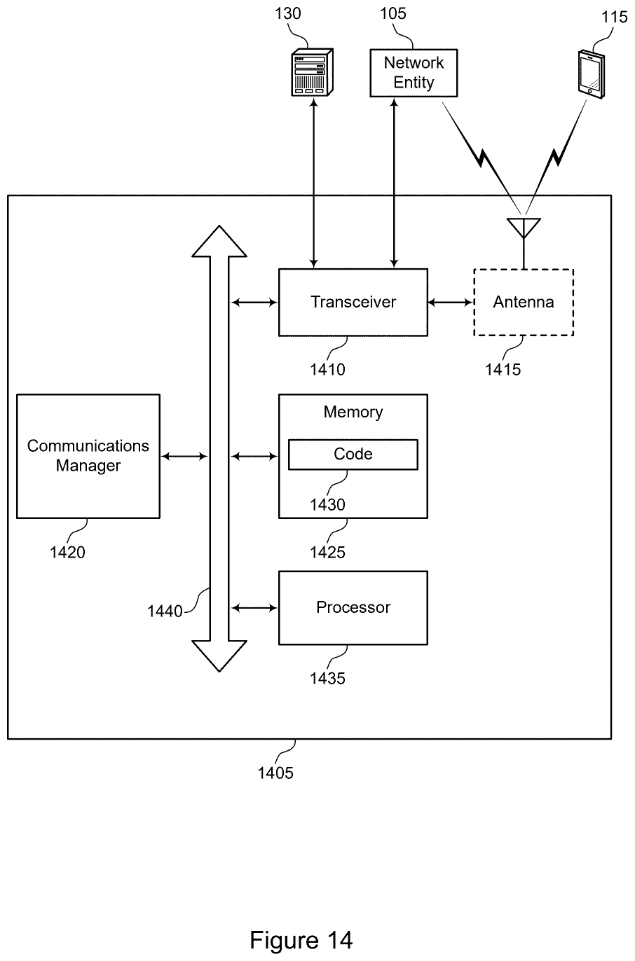

FIG. 14 shows a diagram of a system including a device 1405 that supports BWP switching with CA in accordance with one or more aspects of the present disclosure. The device 1405 may be an example of or include components of a device 1105, a device 1205, or a network entity 105. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (for example, operatively, communicatively, functionally, electronically, electrically) via one or more buses (for example, a bus 1440).

The transceiver 1410 may support bi-directional communications via wired links, wireless links, or both. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (for example, concurrently). The transceiver 1410 may also include a modem to modulate signals, to provide the modulated signals for transmission (for example, by one or more antennas 1415, by a wired transmitter), to receive modulated signals (for example, from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (for example, the at least one processor 1435, the at least one memory 1425, or both), may be included in a chip or chip assembly that is installed in the device 1405. In some examples, the transceiver 1410 may be operable to support communications via one or more communications links (for example, communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some examples, the code 1430 may not be directly executable by a processor of the at least one processor 1435 but may cause a computer (for example, when compiled and executed) to perform functions described herein. In some examples, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (for example, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some examples, the at least one processor 1435 may be configured to operate a memory array using a memory controller. In some other examples, a memory controller may be integrated into one or more of the at least one processor 1435. The at least one processor 1435 may be configured to execute computer-readable instructions stored in a memory (for example, one or more of the at least one memory 1425) to cause the device 1405 to perform various functions (for example, functions or tasks supporting BWP switching with CA). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (for example, one or more physical nodes and supporting software such as operating systems, virtual machines, or container instances) that may host the functions (for example, by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (for example, within) a protocol layer of a protocol stack. In some examples, a bus 1440 may support communications associated with a logical channel of a protocol stack (for example, between protocol layers of a protocol stack), which may include communications performed within a component of the device 1405, or between different components of the device 1405 that may be co-located or located in different locations. The device 1405 may refer to a system in which one or more of the communications manager 1420, the transceiver 1410, the at least one memory 1425, the code 1430, and the at least one processor 1435 may be located in one of the different components or divided between different components.

In some examples, the communications manager 1420 may manage aspects of communications with a core network 130 (for example, via one or more wired or wireless backhaul links). For example, the communications manager 1420 may manage the transfer of data communications for client devices, such as one or more UEs 115. In some examples, the communications manager 1420 may manage communications with one or more other network entities 105 and may include a controller or scheduler for controlling communications with UEs 115 (for example, in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting a non-scheduling DCI signal that indicates a set of multiple active BWP switches for a set of multiple respective CCs, a first active BWP switch of the set of multiple active BWP switches being associated with an uplink BWP. The communications manager 1420 is capable of, configured to, or operable to support a means for communicating in accordance with the set of multiple active BWP switches. In some examples, the communications manager 1420 can be implemented, at least in part, by one or both of a modem and at least one processor 1435.

Additionally, or alternatively, the communications manager 1420 may support wireless communications in accordance with examples as disclosed herein. For example, the communications manager 1420 is capable of, configured to, or operable to support a means for transmitting a set of multiple DCI signals that indicate: a set of multiple active BWP switches for a set of multiple respective sets of CCs; and one or more resources for HARQ-ACK feedback. The communications manager 1420 is capable of, configured to, or operable to support a means for communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback.

By including or configuring the communications manager 1420, the device 1405 may support techniques for improved communication reliability, reduced latency, more efficient utilization of communication resources, and improved coordination between devices.

In some examples, the communications manager 1420 may be configured to perform various operations (for example, receiving, obtaining, monitoring, outputting, transmitting) using or otherwise in cooperation with the transceiver 1410, the one or more antennas 1415, or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of BWP switching with CA, or the at least one processor 1435 and the at least one memory 1425 may be otherwise configured to, individually or collectively, perform or support such operations.

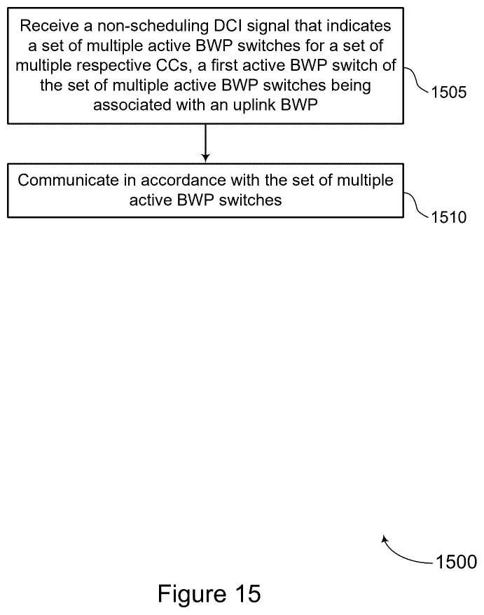

FIG. 15 shows a flowchart illustrating a method 1500 that supports BWP switching with CA in accordance with one or more aspects of the present disclosure. The operations of the method 1500 may be implemented by a UE or its components. For example, the operations of the method 1500 may be performed by a UE 115 as described with reference to FIGS. 1-10. In some examples, a UE may execute a set of instructions to control the functional elements of the UE to perform the described functions. Additionally, or alternatively, the UE may perform aspects of the described functions using special-purpose hardware.

At 1505, the method may include receiving a non-scheduling DCI signal that indicates a set of multiple active BWP switches for a set of multiple respective CCs, a first active BWP switch of the set of multiple active BWP switches being associated with an uplink BWP. The operations of 1505 may be performed in accordance with examples as disclosed herein. In some examples, aspects of the operations of 1505 may be performed by a DCI component 925 as described with reference to FIG. 9.

At 1510, the method may include communicating in accordance with the set of multiple active BWP switches. The operations of 1510 may be performed in accordance with examples as disclosed herein. In some examples, aspects of the operations of 1510 may be performed by a BWP switch component 930 as described with reference to FIG. 9.

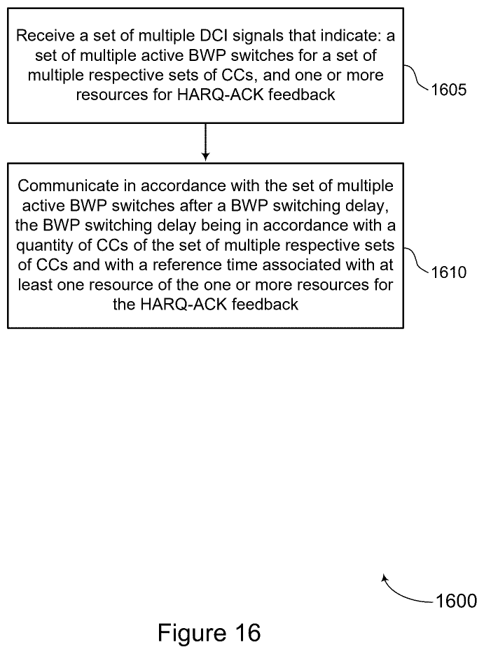

FIG. 16 shows a flowchart illustrating a method 1600 that supports BWP switching with CA in accordance with one or more aspects of the present disclosure. The operations of the method 1600 may be implemented by a UE or its components. For example, the operations of the method 1600 may be performed by a UE 115 as described with reference to FIGS. 1-10. In some examples, a UE may execute a set of instructions to control the functional elements of the UE to perform the described functions. Additionally, or alternatively, the UE may perform aspects of the described functions using special-purpose hardware.

At 1605, the method may include receiving a set of multiple DCI signals that indicate: a set of multiple active BWP switches for a set of multiple respective sets of CCs, and one or more resources for HARQ-ACK feedback. The operations of 1605 may be performed in accordance with examples as disclosed herein. In some examples, aspects of the operations of 1605 may be performed by a DCI component 925 as described with reference to FIG. 9.

At 1610, the method may include communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback. The operations of 1620 may be performed in accordance with examples as disclosed herein. In some examples, aspects of the operations of 1620 may be performed by a BWP switching delay component 935 as described with reference to FIG. 9.

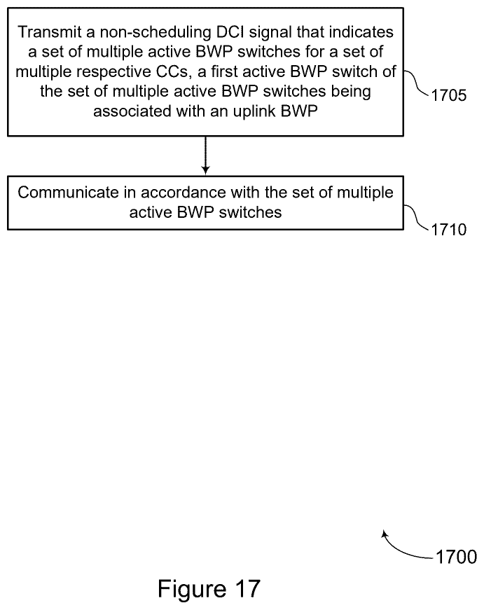

FIG. 17 shows a flowchart illustrating a method 1700 that supports BWP switching with CA in accordance with one or more aspects of the present disclosure. The operations of the method 1700 may be implemented by a network entity or its components. For example, the operations of the method 1700 may be performed by a network entity as described with reference to FIGS. 1-6 and 11-14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a non-scheduling DCI signal that indicates a set of multiple active BWP switches for a set of multiple respective CCs, a first active BWP switch of the set of multiple active BWP switches being associated with an uplink BWP. The operations of 1705 may be performed in accordance with examples as disclosed herein. In some examples, aspects of the operations of 1705 may be performed by a DCI component 1325 as described with reference to FIG. 13.

At 1710, the method may include communicating in accordance with the set of multiple active BWP switches. The operations of 1710 may be performed in accordance with examples as disclosed herein. In some examples, aspects of the operations of 1710 may be performed by a BWP switch component 1330 as described with reference to FIG. 13.

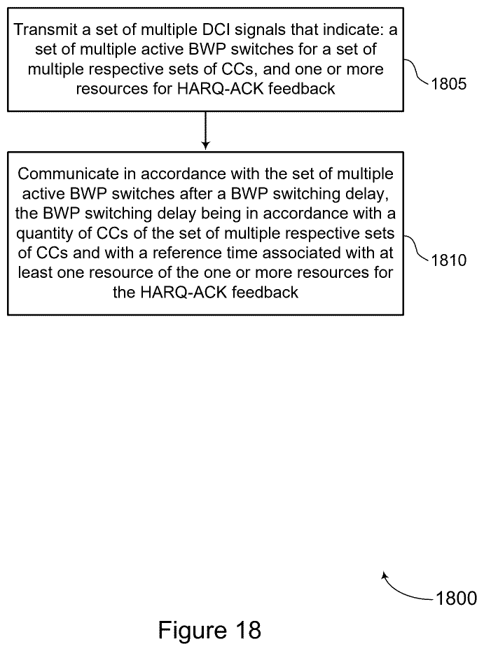

FIG. 18 shows a flowchart illustrating a method 1800 that supports BWP switching with CA in accordance with one or more aspects of the present disclosure. The operations of the method 1800 may be implemented by a network entity or its components. For example, the operations of the method 1800 may be performed by a network entity as described with reference to FIGS. 1-6 and 11-14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting a set of multiple DCI signals that indicate: a set of multiple active BWP switches for a set of multiple respective sets of CCs, and one or more resources for HARQ-ACK feedback. The operations of 1805 may be performed in accordance with examples as disclosed herein. In some examples, aspects of the operations of 1805 may be performed by a DCI component 1325 as described with reference to FIG. 13.

At 1810, the method may include communicating in accordance with the set of multiple active BWP switches after a BWP switching delay, the BWP switching delay being in accordance with a quantity of CCs of the set of multiple respective sets of CCs and with a reference time associated with at least one resource of the one or more resources for the HARQ-ACK feedback. The operations of 1810 may be performed in accordance with examples as disclosed herein. In some examples, aspects of the operations of 1810 may be performed by a BWP switching delay component 1335 as described with reference to FIG. 13.

The following provides an overview of aspects of the present disclosure:

Aspect 1: A method for wireless communications at a UE, comprising: receiving a non-scheduling DCI signal that indicates a plurality of active BWP switches for a plurality of respective CCs, a first active BWP switch of the plurality of active BWP switches being associated with an uplink BWP; and communicating in accordance with the plurality of active BWP switches.

Aspect 2: The method of aspect 1, wherein the non-scheduling DCI signal further indicates a resource for HARQ-ACK feedback, the method further comprising: transmitting, via the resource for HARQ-ACK feedback, a HARQ-ACK signal that acknowledges reception of the non-scheduling DCI signal.

Aspect 3: The method of aspect 2, further comprising: switching from a first plurality of active BWPs to a second plurality of active BWPs in accordance with the plurality of active BWP switches after the HARQ-ACK signal that acknowledges the reception of the non-scheduling DCI signal is transmitted.

Aspect 4: The method of either of aspects 1 or 2, further comprising: switching from a first plurality of active BWPs to a second plurality of active BWPs in accordance with the plurality of active BWP switches after the non-scheduling DCI signal is received.

Aspect 5: The method of any of aspects 1-4, wherein one or more fields of the non-scheduling DCI signal are set to one or more reserved values to indicate that the non-scheduling DCI signal indicates multi-CC BWP switching.

Aspect 6: The method of aspect 5, wherein the one or more fields of the non-scheduling DCI signal set to the one or more reserved values comprise an FDRA field.

Aspect 7: The method of any of aspects 1-6, wherein a set of bits from one or more fields of the non-scheduling DCI signal indicates one or more IDs of one or more respective target BWPs for one or more respective CCs of the plurality of respective CCs.

Aspect 8: The method of aspect 7, wherein the one or more fields of the non-scheduling DCI signal comprise one or more of a TDRA field, an MCS field, an NDI field, an RV field, a HARQ process number field, an antenna ports field, a DMRS sequence initialization field, a VRB-to-PRB mapping field, a PRB bundling size indicator field, or a rate matching indicator field.

Aspect 9: The method of either of aspects 7 or 8, further comprising: receiving an RRC signal that indicates a first subset of CCs and a second subset of CCs, wherein the non-scheduling DCI signal indicates: a single target BWP ID for both a first uplink BWP and a first downlink BWP corresponding to a same first CC of the first subset of CCs, and separate target BWP IDs for a second uplink BWP and a second downlink BWP corresponding to a same second CC of the second subset of CCs.

Aspect 10: The method of aspect 9, wherein a first subset of the set of bits indicates one or more first downlink BWP IDs for the first subset of CCs, a second subset of the set of bits indicates one or more second downlink BWP IDs for downlink CCs of the second subset of CCs, and a third subset of the set of bits indicates one or more uplink BWP IDs for uplink CCs of the second subset of CCs.

Aspect 11: The method of aspect 9, wherein a first subset of the set of bits indicates one or more downlink BWP IDs for the first subset of CCs, a one bit flag of the set of bits indicates either uplink or downlink for the second subset of CCs, and a second subset of the set of bits indicates one or more uplink or downlink BWP IDs for the second subset of CCs in accordance with the one bit flag.

Aspect 12: The method of aspect 9, wherein a first subset of the set of bits indicates one or more downlink BWP IDs for the first subset of CCs, a set of one bit flags of the set of bits indicates either uplink or downlink respectively for each CC of the second subset of CCs, and a second subset of the set of bits indicates one or more uplink or downlink BWP IDs for the second subset of CCs in accordance with the set of one bit flags.

Aspect 13: The method of aspect 9, wherein a first subset of the set of bits indicates one or more downlink BWP IDs for the first subset of CCs and for downlink CCs of the second subset of CCs and a second subset of the set of bits indicates one or more uplink BWP IDs for uplink CCs of the second subset of CCs.

Aspect 14: The method of aspect 9, wherein the set of bits jointly indicates a combination of one or more first downlink BWP IDs for the first subset of CCs, one or more second downlink BWP IDs for downlink CCs of the second subset of CCs, and one or more uplink BWP IDs for uplink CCs of the second subset of CCs.

Aspect 15: The method of any of aspects 9-14, wherein the first subset of CCs corresponds to TDD CCs and the second subset of CCs corresponds to FDD CCs.

Aspect 16: The method of any of aspects 1-15, wherein the non-scheduling DCI signal further indicates a first CC in accordance with one of a carrier indicator field of the non-scheduling DCI signal or the non-scheduling DCI signal being received via the first CC; and a BWP indicator field of the non-scheduling DCI signal indicates an ID of a target BWP for the first CC.

Aspect 17: The method of any of aspects 1-16, further comprising: receiving an RRC signal that configures, for a set of CCs, one or more of a respective quantity of bits for indicating an ID of a target BWP for each CC of the set of CCs, a respective set of BWP IDs that can be indicated for each CC of the set of CCs, or a set of combinations of BWP IDs that can be indicated for the set of CCs, wherein the non-scheduling DCI signal indicates the plurality of active BWP switches for the plurality of respective CCs in accordance with the RRC signal.

Aspect 18: The method of aspect 17, wherein the set of CCs comprises either the plurality of respective CCs or a subset of the plurality of respective CCs.

Aspect 19: The method of any of aspects 1-18, further comprising: transmitting a UE capability signal that indicates a relaxation of a restriction for the non-scheduling DCI signal.

Aspect 20: The method of any of aspects 1-19, wherein the non-scheduling DCI signal is received via a scheduling CC for the plurality of respective CCs.

Aspect 21: The method of aspect 20, further comprising: transmitting a UE capability signal that indicates a quantity of scheduling CCs that can indicate BWP switching for a CC.

Aspect 22: The method of either of aspects 20 or 21, wherein the non-scheduling DCI signal comprises one of a reserved value for a carrier indicator field or no value for the carrier indicator field.

Aspect 23: The method of aspect 22, further comprising: transmitting a UE capability signal that indicates a quantity of carrier indicator field values of the non-scheduling DCI signal that can indicate the BWP switching for the plurality of respective CCs.

Aspect 24: The method of any of aspects 20-23, wherein the scheduling CC and each CC of the plurality of respective CCs are associated with one or more of a same cell group, a same frequency band, a same frequency range, a same SCS, or a same duplex mode.

Aspect 25: The method of aspect 24, further comprising: transmitting a UE capability signal that indicates one or more of a quantity of CCs supported for the plurality of active BWP switches, first support for the plurality of respective CCs to be associated with different cell groups, second support for the plurality of respective CCs to be associated with different frequency bands, third support for the plurality of respective CCs to be associated with different frequency ranges, fourth support for the plurality of respective CCs to be associated with different SCSs, or fifth support for the plurality of respective CCs to be associated with different duplex modes.

Aspect 26: The method of any of aspects 1-25, wherein a second active BWP switch of the plurality of active BWP switches is associated with a downlink BWP.

Aspect 27: The method of aspect 26, wherein the second active BWP switch indicates to switch from a first non-dormant downlink BWP to a second non-dormant BWP.

Aspect 28: The method of any of aspects 1-27, wherein the non-scheduling DCI signal comprises one or more CRC bits that are scrambled in accordance with one of a C-RNTI or a CS-RNTI.

Aspect 29: The method of any of aspects 1-28, wherein the non-scheduling DCI signal refrains from scheduling a data transmission for the UE.

Aspect 30: A method for wireless communications at a UE, comprising: receiving a plurality of DCI signals that indicate: a plurality of active BWP switches for a plurality of respective sets of CCs, and one or more resources for HARQ-ACK feedback; and communicating in accordance with the plurality of active BWP switches after a BWP switching delay, the BWP switching delay being in accordance with a quantity of CCs of the plurality of respective sets of CCs and with a reference time associated with at least one resource of the one or more resources for the HARQ-ACK feedback.

Aspect 31: The method of aspect 30, further comprising: starting the BWP switching delay at the reference time, wherein the communicating occurs after a duration of the BWP switching delay.

Aspect 32: The method of either of aspects 30 or 31, wherein the plurality of DCI signals indicate a same resource for the HARQ-ACK feedback; and the reference time corresponds to the same resource for the HARQ-ACK feedback.

Aspect 33: The method of either of aspects 30 or 31, wherein the plurality of DCI signals indicate a plurality of resources for the HARQ-ACK feedback; and the reference time corresponds to a first time domain resource of the plurality of resources for the HARQ-ACK feedback that occurs earliest or latest in time.

Aspect 34: The method of any of aspects 30-33, wherein a set of the plurality of respective sets of CCs consists of one or more CCs.

Aspect 35: A method for wireless communications at a network entity, comprising: transmitting a non-scheduling DCI signal that indicates a plurality of active BWP switches for a plurality of respective CCs, a first active BWP switch of the plurality of active BWP switches being associated with an uplink BWP; and communicating in accordance with the plurality of active BWP switches.

Aspect 36: The method of aspect 35, wherein the non-scheduling DCI signal further indicates a resource for HARQ-ACK feedback, the method further comprising: receiving, via the resource for HARQ-ACK feedback, a HARQ-ACK signal that acknowledges reception of the non-scheduling DCI signal at a UE.

Aspect 37: The method of either of aspects 35 or 36, wherein one or more fields of the non-scheduling DCI signal are set to one or more reserved values to indicate that the non-scheduling DCI signal indicates multi-CC BWP switching.

Aspect 38: The method of aspect 37, wherein the one or more fields of the non-scheduling DCI signal set to the one or more reserved values comprise an FDRA field.

Aspect 39: The method of any of aspects 35-38, wherein a set of bits from one or more fields of the non-scheduling DCI signal indicates one or more IDs of one or more respective target BWPs for one or more respective CCs of the plurality of respective CCs.

Aspect 40: The method of aspect 39, wherein the one or more fields of the non-scheduling DCI signal comprise one or more of a TDRA field, an MCS field, an NDI field, an RV field, a HARQ process number field, an antenna ports field, a DMRS sequence initialization field, a VRB-to-PRB mapping field, a PRB bundling size indicator field, or a rate matching indicator field.

Aspect 41: The method of either of aspects 39 or 40, further comprising: transmitting an RRC signal that indicates a first subset of CCs and a second subset of CCs, wherein the non-scheduling DCI signal indicates: a single target BWP ID for both a first uplink BWP and a first downlink BWP corresponding to a same first CC of the first subset of CCs, and separate target BWP IDs for a second uplink BWP and a second downlink BWP corresponding to a same second CC of the second subset of CCs.

Aspect 42: The method of aspect 41, wherein a first subset of the set of bits indicates one or more first downlink BWP IDs for the first subset of CCs, a second subset of the set of bits indicates one or more second downlink BWP IDs for downlink CCs of the second subset of CCs, and a third subset of the set of bits indicates one or more uplink BWP IDs for uplink CCs of the second subset of CCs.

Aspect 43: The method of aspect 41, wherein a first subset of the set of bits indicates one or more downlink BWP IDs for the first subset of CCs, a one bit flag of the set of bits indicates either uplink or downlink for the second subset of CCs, and a second subset of the set of bits indicates one or more uplink or downlink BWP IDs for the second subset of CCs in accordance with the one bit flag.

Aspect 44: The method of aspect 41, wherein a first subset of the set of bits indicates one or more downlink BWP IDs for the first subset of CCs, a set of one bit flags of the set of bits indicates either uplink or downlink respectively for each CC of the second subset of CCs, and a second subset of the set of bits indicates one or more uplink or downlink BWP IDs for the second subset of CCs in accordance with the set of one bit flags.

Aspect 45: The method of aspect 41, wherein a first subset of the set of bits indicates one or more downlink BWP IDs for the first subset of CCs and for downlink CCs of the second subset of CCs and a second subset of the set of bits indicates one or more uplink BWP IDs for uplink CCs of the second subset of CCs.

Aspect 46: The method of aspect 41, wherein the set of bits jointly indicates a combination of one or more first downlink BWP IDs for the first subset of CCs, one or more second downlink BWP IDs for downlink CCs of the second subset of CCs, and one or more uplink BWP IDs for uplink CCs of the second subset of CCs.

Aspect 47: The method of any of aspects 41-46, wherein the first subset of CCs corresponds to TDD CCs and the second subset of CCs corresponds to FDD CCs.

Aspect 48: The method of any of aspects 35-47, wherein the non-scheduling DCI signal further indicates a first CC in accordance with one of a carrier indicator field of the non-scheduling DCI signal or the non-scheduling DCI signal being transmitted via the first CC; and a BWP indicator field of the non-scheduling DCI signal indicates an ID of a target BWP for the first CC.

Aspect 49: The method of any of aspects 35-48, further comprising: transmitting a RRC signal that configures, for a set of CCs, one or more of a respective quantity of bits for indicating an ID of a target BWP for each CC of the set of CCs, a respective set of BWP IDs that can be indicated for each CC of the set of CCs, or a set of combinations of BWP IDs that can be indicated for the set of CCs, wherein the non-scheduling DCI signal indicates the plurality of active BWP switches for the plurality of respective CCs in accordance with the RRC signal.

Aspect 50: The method of aspect 49, wherein the set of CCs comprises either the plurality of respective CCs or a subset of the plurality of respective CCs.

Aspect 51: The method of any of aspects 35-50, further comprising: receiving a UE capability signal for a UE that indicates a relaxation of a restriction for the non-scheduling DCI signal.

Aspect 52: The method of any of aspects 35-51, wherein the non-scheduling DCI signal is transmitted via a scheduling CC for the plurality of respective CCs.

Aspect 53: The method of aspect 52, further comprising: receiving a UE capability signal for a UE that indicates a quantity of scheduling CCs that can indicate BWP switching for a CC.

Aspect 54: The method of either of aspects 52 or 53, wherein the non-scheduling DCI signal comprises one of a reserved value for a carrier indicator field or no value for the carrier indicator field.

Aspect 55: The method of aspect 54, further comprising: receiving a UE capability signal for a UE that indicates a quantity of carrier indicator field values of the non-scheduling DCI signal that can indicate the BWP switching for the plurality of respective CCs.

Aspect 56: The method of any of aspects 52-55, wherein the scheduling CC and each CC of the plurality of respective CCs are associated with one or more of a same cell group, a same frequency band, a same frequency range, a same SCS, or a same duplex mode.

Aspect 57: The method of aspect 56, further comprising: receiving a UE capability signal for a UE that indicates one or more of a quantity of CCs supported for the plurality of active BWP switches, first support for the plurality of respective CCs to be associated with different cell groups, second support for the plurality of respective CCs to be associated with different frequency bands, third support for the plurality of respective CCs to be associated with different frequency ranges, fourth support for the plurality of respective CCs to be associated with different SCSs, or fifth support for the plurality of respective CCs to be associated with different duplex modes.

Aspect 58: The method of any of aspects 35-57, wherein a second active BWP switch of the plurality of active BWP switches is associated with a downlink BWP.

Aspect 59: The method of aspect 58, wherein the second active BWP switch indicates to switch from a first non-dormant downlink BWP to a second non-dormant BWP.

Aspect 60: The method of any of aspects 35-59, wherein the non-scheduling DCI signal comprises one or more CRC bits that are scrambled in accordance with one of a C-RNTI or a CS-RNTI.

Aspect 61: The method of any of aspects 35-60, wherein the non-scheduling DCI signal refrains from scheduling a data transmission for the UE.

Aspect 62: A method for wireless communications at a network entity, comprising: transmitting a plurality of DCI signals that indicate: a plurality of active BWP switches for a plurality of respective sets of CCs, and one or more resources for HARQ-ACK feedback; and communicating in accordance with the plurality of active BWP switches after a BWP switching delay, the BWP switching delay being in accordance with a quantity of CCs of the plurality of respective sets of CCs and with a reference time associated with at least one resource of the one or more resources for the HARQ-ACK feedback.

Aspect 63: The method of aspect 62, further comprising: starting the BWP switching delay at the reference time, wherein the communicating occurs after a duration of the BWP switching delay.

Aspect 64: The method of either of aspects 62 or 63, wherein the plurality of DCI signals indicate a same resource for the HARQ-ACK feedback; and the reference time corresponds to the same resource for the HARQ-ACK feedback.

Aspect 65: The method of either of aspects 62 or 63, wherein the plurality of DCI signals indicate a plurality of resources for the HARQ-ACK feedback; and the reference time corresponds to a first time domain resource of the plurality of resources for the HARQ-ACK feedback that occurs earliest or latest in time.

Aspect 66: The method of any of aspects 62-65, wherein a set of the plurality of respective sets of CCs consists of one or more CCs.

Aspect 67: A UE, comprising: a processing system that includes processor circuitry and memory circuitry that stores code, the processing system configured to cause the UE to perform a method of any of aspects 1-29.

Aspect 68: A UE for wireless communications, comprising at least one means for performing a method of any of aspects 1-29.

Aspect 69: A non-transitory computer-readable medium storing code for wireless communications, the code comprising instructions executable by one or more processors to perform a method of any of aspects 1-29.

Aspect 70: A UE, comprising: a processing system that includes processor circuitry and memory circuitry that stores code, the processing system configured to cause the UE to perform a method of any of aspects 30-34.

Aspect 71: A UE for wireless communications, comprising at least one means for performing a method of any of aspects 30-34.

Aspect 72: A non-transitory computer-readable medium storing code for wireless communications, the code comprising instructions executable by one or more processors to perform a method of any of aspects 30-34.

Aspect 73: A network entity, comprising: a processing system that includes processor circuitry and memory circuitry that stores code, the processing system configured to cause the network entity to perform a method of any of aspects 35-61.

Aspect 74: A network entity for wireless communications, comprising at least one means for performing a method of any of aspects 35-61.

Aspect 75: A non-transitory computer-readable medium storing code for wireless communications, the code comprising instructions executable by one or more processors to perform a method of any of aspects 35-61.

Aspect 76: A network entity, comprising: a processing system that includes processor circuitry and memory circuitry that stores code, the processing system configured to cause the network entity to perform a method of any of aspects 62-66.

Aspect 77: A network entity for wireless communications, comprising at least one means for performing a method of any of aspects 62-66.

Aspect 78: A non-transitory computer-readable medium storing code for wireless communications, the code comprising instructions executable by one or more processors to perform a method of any of aspects 62-66.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (in other words, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), or ascertaining, among other examples. Also, “determining” can include receiving (for example, receiving information), or accessing (for example, accessing data stored in memory), among other examples. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive a non-scheduling downlink control information signal that indicates a plurality of active bandwidth part switches for a plurality of respective component carriers, a first active bandwidth part switch of the plurality of active bandwidth part switches being associated with an uplink bandwidth part; and
communicate in accordance with the plurality of active bandwidth part switches.

2. The UE of claim 1, wherein the non-scheduling downlink control information signal further indicates a resource for hybrid automatic repeat request acknowledgment feedback, and the processing system is further configured to cause the UE to transmit, via the resource for hybrid automatic repeat request acknowledgment feedback, a hybrid automatic repeat request acknowledgment signal that acknowledges reception of the non-scheduling downlink control information signal.

3. The UE of claim 2, wherein the processing system is further configured to cause the UE to switch from a first plurality of active bandwidth parts to a second plurality of active bandwidth parts in accordance with the plurality of active bandwidth part switches after the hybrid automatic repeat request acknowledgment signal that acknowledges the reception of the non-scheduling downlink control information signal is transmitted.

4. The UE of claim 1, wherein one or more fields of the non-scheduling downlink control information signal are set to one or more reserved values to indicate that the non-scheduling downlink control information signal indicates multi-component carrier bandwidth part switching.

5. The UE of claim 1, wherein a set of bits from one or more fields of the non-scheduling downlink control information signal indicates one or more identifiers of one or more respective target bandwidth parts for one or more respective component carriers of the plurality of respective component carriers.

6. The UE of claim 5, wherein the processing system is further configured to cause the UE to:
receive a radio resource control signal that indicates a first subset of component carriers and a second subset of component carriers, wherein the non-scheduling downlink control information signal indicates:
a single target bandwidth part identifier for both a first uplink bandwidth part and a first downlink bandwidth part correspond to a same first component carrier of the first subset of component carriers, and
separate target bandwidth part identifiers for a second uplink bandwidth part and a second downlink bandwidth part correspond to a same second component carrier of the second subset of component carriers.

7. The UE of claim 6, wherein the first subset of component carriers corresponds to time-division duplexed component carriers and the second subset of component carriers corresponds to frequency-division duplexed component carriers.

8. The UE of claim 1, wherein:
the non-scheduling downlink control information signal further indicates a first component carrier in accordance with one of a carrier indicator field of the non-scheduling downlink control information signal or the non-scheduling downlink control information signal being received via the first component carrier; and
a bandwidth part indicator field of the non-scheduling downlink control information signal indicates an identifier of a target bandwidth part for the first component carrier.

9. The UE of claim 1, wherein the processing system is further configured to cause the UE to receive a radio resource control signal that configures, for a set of component carriers, one or more of a respective quantity of bits for indicating an identifier of a target bandwidth part for each component carrier of the set of component carriers, a respective set of bandwidth part identifiers that can be indicated for each component carrier of the set of component carriers, or a set of combinations of bandwidth part identifiers that can be indicated for the set of component carriers, wherein the non-scheduling downlink control information signal indicates the plurality of active bandwidth part switches for the plurality of respective component carriers in accordance with the radio resource control signal.

10. The UE of claim 9, wherein the set of component carriers comprises one of the plurality of respective component carriers or a subset of the plurality of respective component carriers.

11. The UE of claim 1, wherein a second active bandwidth part switch of the plurality of active bandwidth part switches is associated with a downlink bandwidth part.

12. The UE of claim 11, wherein the second active bandwidth part switch indicates to switch from a first non-dormant downlink bandwidth part to a second non-dormant bandwidth part.

13. A user equipment (UE), comprising:
a processing system that includes processor circuitry and memory circuitry that stores code, the processing system configured to cause the UE to:
receive a plurality of downlink control information signals that indicate:
a plurality of active bandwidth part switches for a plurality of respective sets of component carriers, and
one or more resources for hybrid automatic repeat request acknowledgment feedback; and
communicate in accordance with the plurality of active bandwidth part switches after a bandwidth part switching delay, the bandwidth part switching delay being in accordance with a quantity of component carriers of the plurality of respective sets of component carriers and with a reference time associated with at least one resource of the one or more resources for the hybrid automatic repeat request acknowledgment feedback.

14. The UE of claim 13, wherein the processing system is further configured to cause the UE to start the bandwidth part switching delay at the reference time, wherein the communicating occurs after a duration of the bandwidth part switching delay.

15. The UE of claim 13, wherein:
the plurality of downlink control information signals indicate a same resource for the hybrid automatic repeat request acknowledgment feedback; and
the reference time corresponds to the same resource for the hybrid automatic repeat request acknowledgment feedback.

16. The UE of claim 13, wherein:
the plurality of downlink control information signals indicate a plurality of resources for the hybrid automatic repeat request acknowledgment feedback; and
the reference time corresponds to a first time domain resource of the plurality of resources for the hybrid automatic repeat request acknowledgment feedback that occurs earliest or latest in time.

17. A network entity, comprising:
a processing system that includes processor circuitry and memory circuitry that stores code, the processing system configured to cause the network entity to:
transmit a non-scheduling downlink control information signal that indicates a plurality of active bandwidth part switches for a plurality of respective component carriers, a first active bandwidth part switch of the plurality of active bandwidth part switches being associated with an uplink bandwidth part; and
communicate in accordance with the plurality of active bandwidth part switches.

18. The network entity of claim 17, wherein the non-scheduling downlink control information signal further indicates a resource for hybrid automatic repeat request acknowledgment feedback, and the processing system is further configured to cause the network entity to receive, via the resource for hybrid automatic repeat request acknowledgment feedback, a hybrid automatic repeat request acknowledgment signal that acknowledges reception of the non-scheduling downlink control information signal at a user equipment (UE).

19. The network entity of claim 17, wherein one or more fields of the non-scheduling downlink control information signal are set to one or more reserved values to indicate that the non-scheduling downlink control information signal indicates multi-component carrier bandwidth part switching.

20. The network entity of claim 17, wherein a set of bits from one or more fields of the non-scheduling downlink control information signal indicates one or more identifiers of one or more respective target bandwidth parts for one or more respective component carriers of the plurality of respective component carriers.

21. The network entity of claim 20, wherein the processing system is further configured to cause the network entity to:
transmit a radio resource control signal that indicates a first subset of component carriers and a second subset of component carriers, wherein the non-scheduling downlink control information signal indicates:
a single target bandwidth part identifier for both a first uplink bandwidth part and a first downlink bandwidth part corresponding to a same first component carrier of the first subset of component carriers, and
separate target bandwidth part identifiers for a second uplink bandwidth part and a second downlink bandwidth part corresponding to a same second component carrier of the second subset of component carriers.

22. The network entity of claim 21, wherein the first subset of component carriers corresponds to time-division duplexed component carriers and the second subset of component carriers corresponds to frequency-division duplexed component carriers.

23. The network entity of claim 17, wherein:
the non-scheduling downlink control information signal further indicates a first component carrier in accordance with one of a carrier indicator field of the non-scheduling downlink control information signal or the non-scheduling downlink control information signal being transmitted via the first component carrier; and
a bandwidth part indicator field of the non-scheduling downlink control information signal indicates an identifier of a target bandwidth part for the first component carrier.

24. The network entity of claim 17, wherein the processing system is further configured to cause the network entity to transmit a radio resource control signal that configures, for a set of component carriers, one or more of a respective quantity of bits for indicating an identifier of a target bandwidth part for each component carrier of the set of component carriers, a respective set of bandwidth part identifiers that can be indicated for each component carrier of the set of component carriers, or a set of combinations of bandwidth part identifiers that can be indicated for the set of component carriers, wherein the non-scheduling downlink control information signal indicates the plurality of active bandwidth part switches for the plurality of respective component carriers in accordance with the radio resource control signal.

25. The network entity of claim 24, wherein the set of component carriers comprises one of the plurality of respective component carriers or a subset of the plurality of respective component carriers.

26. The network entity of claim 17, wherein a second active bandwidth part switch of the plurality of active bandwidth part switches is associated with a downlink bandwidth part.

27. A network entity, comprising:
a processing system that includes processor circuitry and memory circuitry that stores code, the processing system configured to cause the network entity to:
transmit a plurality of downlink control information signals that indicate:
a plurality of active bandwidth part switches for a plurality of respective sets of component carriers, and
one or more resources for hybrid automatic repeat request acknowledgment feedback; and
communicate in accordance with the plurality of active bandwidth part switches after a bandwidth part switching delay, the bandwidth part switching delay being in accordance with a quantity of component carriers of the plurality of respective sets of component carriers and with a reference time associated with at least one resource of the one or more resources for the hybrid automatic repeat request acknowledgment feedback.

28. The network entity of claim 27, wherein the processing system is further configured to cause the network entity to start the bandwidth part switching delay at the reference time, wherein the communicating occurs after a duration of the bandwidth part switching delay.

29. The network entity of claim 27, wherein:
the plurality of downlink control information signals indicate a same resource for the hybrid automatic repeat request acknowledgment feedback; and
the reference time corresponds to the same resource for the hybrid automatic repeat request acknowledgment feedback.

30. The network entity of claim 27, wherein:
the plurality of downlink control information signals indicate a plurality of resources for the hybrid automatic repeat request acknowledgment feedback; and
the reference time corresponds to a first time domain resource of the plurality of resources for the hybrid automatic repeat request acknowledgment feedback that occurs earliest or latest in time.
